(19) United States
(12) Patent Application Publication
(10) Pub. No.: US 2014/0240370 A1
(43) Pub. Date: Aug. 28, 2014

(54) DISPLAY, METHOD OF MANUFACTURING DISPLAY, METHOD OF DRIVING DISPLAY, AND ELECTRONIC APPARATUS

(71) Applicant: Sony Corporation, Tokyo (JP)

(72) Inventors: Takashi SAKAIRI, Kanagawa (JP); Yoshiya HAGIMOTO, Kanagawa (JP); Hayato IWAMOTO, Kanagawa (JP); Koichiro SAGA, Tokyo (JP); Nobutoshi FUJII, Kanagawa (JP)

(73) Assignee: Sony Corporation, Tokyo (JP)

(21) Appl. No.: 14/176,656

(22) Filed: Feb. 10, 2014

(30) Foreign Application Priority Data
Feb. 27, 2013 (JP) 2013-037375
Jul. 31, 2013 (JP) 2013-159320

(51) Int. Cl. G09G 3/32

(52) U.S. Cl. CPC G09G 3/3225
USPC 345/690; 345/77; 29/592

(57) ABSTRACT

A display includes: a light-emitting section provided in a display region; and a light-receiving section provided in the display region, and configured to receive light from the light-emitting section.

### CROSS REFERENCES TO RELATED APPLICATIONS

The present application claims priority to Japanese Priority Patent Application JP 2013-037375 filed in the Japan Patent Office on Feb. 27, 2013, Japanese Priority Patent Application JP 2013-159320 filed in the Japan Patent Office on Jul. 31, 2013, the entire content of which is hereby incorporated by reference.

### BACKGROUND

The present application relates to: a display that has a light-emitting section including organic electroluminescence (EL) elements; a method of manufacturing a display; a method of driving a display; and an electronic apparatus.

In recent years, displays that use organic electroluminescence (EL) elements or some other similar elements have attracted attention, as one example of flat-panel displays. Such self-luminous displays feature a wide viewing angle and low power consumption. Also, since the organic EL elements are expected to be able to sufficiently respond to high-speed and high-definition image signals, they have been developed toward the practical use.

Self-luminous displays have a disadvantage in that the luminance of a screen is prone to become nonuniform. There are some reasons for this luminance nonuniformity. One of the reasons is that performances, more specifically, threshold voltages Vth of transistors that drive elements vary during the manufacturing process. Another reason is that as a result of displaying a white image on part of a screen over a long time, an element in this part deteriorates, thus causing a burn-in phenomenon.

Providing a circuit (correction circuit) that adjusts the luminescence intensity of each element has been proposed, as one example of methods of suppressing the luminance nonuniformity of a screen as described above. For example, Japanese Unexamined Patent Application Publication No. 2010-78853 describes a technique for providing light-receiving sections outside a display region having pixel arrays and correcting the luminescence intensities of light-emitting elements by detecting light from these light-emitting elements with the light-receiving sections.

### SUMMARY

Unfortunately the above methods have failed to sufficiently prevent the luminance nonuniformity.

It is desirable to provide a display, a method of manufacturing a display, a method of driving a display, and an electronic apparatus that are capable of suppressing luminance nonuniformity effectively.

A display according to an embodiment of the present application includes: a light-emitting section provided in a display region; and a light-receiving section provided in the display region, and configured to receive light from the light-emitting section.

An electronic apparatus according to an embodiment of the present application is provided with a display. The display includes: a light-emitting section provided in a display region; and a light-receiving section provided in the display region, and configured to receive light from the light-emitting section.

According to the display or the electronic apparatus in the above-described embodiment of the present application, providing the light-receiving section within the display region decreases a distance between the light-emitting section and the light-receiving section. For example, the light-receiving section may be provided for each pixel.

A method of driving a display according to an embodiment of the present application includes: driving, using a pixel drive circuit, a light-emitting section that is provided in a display region; receiving, using a light-receiving section that is provided in the display region, light from the light-emitting section; and sending a correction signal to the pixel drive circuit from a correction circuit in accordance with an amount of the light received by the light-receiving section.

A method of manufacturing a display according to an embodiment of the present application includes: forming a light-emitting section in a display region; and forming a light-receiving section in the display region, the light-receiving section being configured to receive light from the light-emitting section.

According to the display, the method of manufacturing a display, the method of driving a display, and the electronic apparatus in the above-described embodiment of the present application, the light-receiving section is provided within the display region. This enables the distance to be decreased between the light-emitting section and the light-receiving section. Therefore, it is possible to increase the sensitivity of the light-receiving section, thereby suppressing the luminance nonuniformity effectively.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 illustrates a configuration of a cross section of a display according to a first embodiment of the present application.

FIG. 2 illustrates an overall configuration of the display in FIG. 1.

FIG. 3 illustrates an exemplary configuration of a pixel drive circuit in FIG. 2.

FIG. 4 is an explanatory block diagram of a correction circuit in the display in FIG. 1.

FIG. 5A is a cross-section view illustrating a process for manufacturing the display (substrate) in FIG. 1.

FIG. 5B is a cross-section view illustrating a process subsequent to that in FIG. 5A.

FIG. 5C is a cross-section view illustrating a process subsequent to that in FIG. 5B.

FIG. 5D is a cross-section view illustrating a process subsequent to that in FIG. 5C.

FIG. 6A is a cross-section view illustrating a process for manufacturing the display (counter substrate) in FIG. 1.

FIG. 6B is a cross-section view illustrating a process subsequent to that in FIG. 6A.

FIG. 7 is a cross-section view illustrating an operation of the display in FIG. 1.

FIG. 8 is an explanatory view of a luminance correction operation performed by the display in FIG. 1.

FIG. 9 illustrates a planar configuration of a display according to a comparative example.

FIG. 10 illustrates a configuration of a cross-section of another exemplary display in FIG. 1.

FIG. 11 illustrates a configuration of a cross section of a display according to a modification 1.

FIG. 12 is an explanatory cross section view of a function of a reflection section in FIG. 11.

FIG. 13 is a cross-section view illustrating an exemplary method of forming the reflection section in FIG. 11.

FIG. 14 is a cross-section view illustrating another exemplary method of forming the reflection section in FIG. 11.

FIG. 15 is an explanatory cross-section view of a method of forming the reflection section in FIGS. 13 and 14.

FIG. 16 illustrates a configuration of a cross section of a display according to a second embodiment of the present application.

FIG. 17A illustrates another exemplary configuration of a cross section of a shield section in FIG. 16.

FIG. 17B illustrates still another exemplary configuration of the cross section of the shield section in FIG. 16.

FIG. 18A illustrates a first exemplary planar configuration of the shield section in FIG. 16.

FIG. 18B is a plan view illustrating a second exemplary shield section in FIG. 16.

FIG. 18C is a plan view illustrating a third exemplary configuration of the shield section in FIG. 16.

FIG. 18D is a plan view illustrating a fourth exemplary configuration of the shield section in FIG. 16.

FIG. 19 is an explanatory cross section view of a function of the shield section in FIG. 16.

FIG. 20 is a cross-section view illustrating an exemplary process for manufacturing the display in FIG. 16.

FIG. 21 illustrates a configuration of a cross section of a display according to a modification 2.

FIG. 22 illustrates a configuration of a cross section of a main part of a display according to a third embodiment of the present application.

FIG. 23A is a cross-section view illustrating an exemplary process for manufacturing the display in FIG. 22.

FIG. 23B is a cross-section view illustrating a process subsequent to that in FIG. 23A.

FIG. 23C is a cross-section view illustrating a process subsequent to that in FIG. 23B.

FIG. 24A is a cross-section view illustrating a process subsequent to that in FIG. 23C.

FIG. 24B is a cross-section view illustrating a process subsequent to that in FIG. 24A.

FIG. 24C is a cross-section view illustrating a process subsequent to that in FIG. 24B.

FIG. 25A is a cross-section view illustrating a process subsequent to that in FIG. 24C.

FIG. 25B is a cross-section view illustrating a process subsequent to that in FIG. 25A.

FIG. 25C is a cross-section view illustrating a process subsequent to that in FIG. 25B.

FIG. 26 illustrates an outline of a planar configuration of a module that includes the display illustrated in the FIG. 1 or the like.

FIG. 27 is a perspective view illustrating an appearance of an exemplary application 1.

FIG. 28A is a perspective view illustrating an appearance of an exemplary application 2 as seen from the front.

FIG. 28B is a perspective view illustrating an appearance of the exemplary application 2 as seen from the rear.

FIG. 29 is a perspective view illustrating an appearance of an exemplary application 3.

FIG. 30 is a perspective view illustrating an appearance of an exemplary application 4.

FIG. 31A illustrates an exemplary application 5 in a closed state.

FIG. 31B illustrates the exemplary application 5 in an opened state.

### DETAILED DESCRIPTION

Hereinafter some embodiments of the present application will be described in detail, with reference to the drawings. The description will be given in the following order.

1. First embodiment (a display in which a light-receiving section is disposed in an interior of a substrate)
2. Modification 1 (an example of providing a reflecting section having a parabolic curved surface)
3. Second embodiment (a display in which a shield section is disposed between a light-receiving section and a transistor in a substrate)
4. Modification 2 (an example of providing a light-blocking shield section)
5. Third embodiment (a display in which a light-receiving section is disposed on a surface of a substrate)

### First Embodiment

(Overall Configuration of Display)

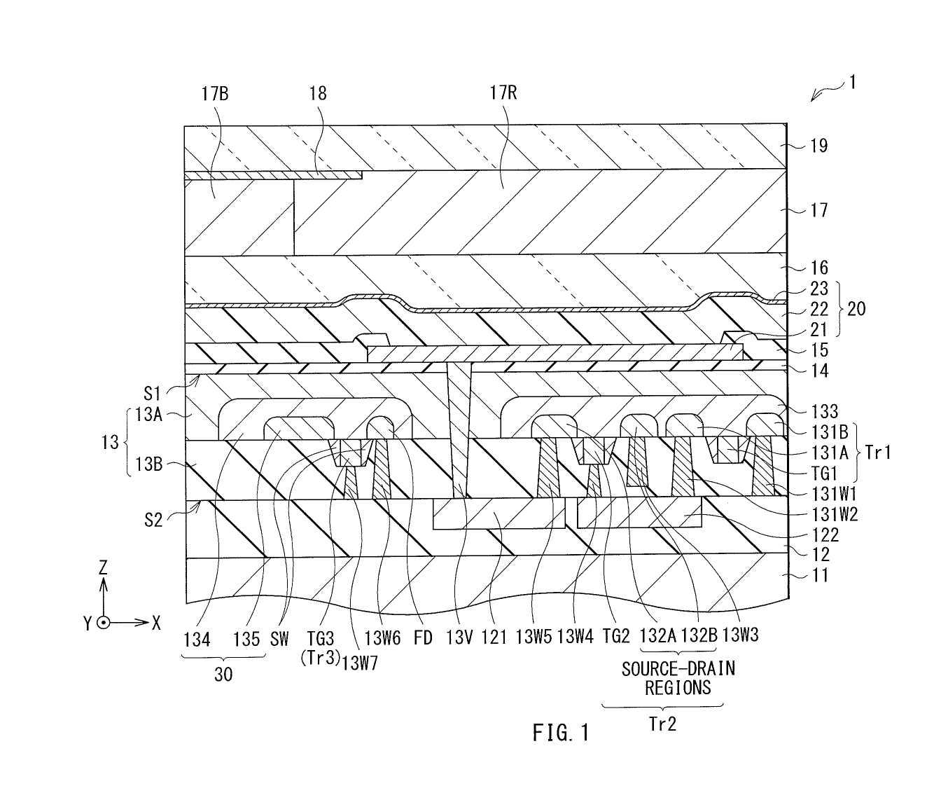

FIG. 1 illustrates a configuration of a cross section of a display (display 1) according to a first embodiment of the present application. The display 1 is of a self-luminous type, and has a light-emitting section 20 on a surface (surface S1) of a substrate 13. The light-emitting section 20 is provided between the substrate 13 (surface S1) and a counter substrate 19. In addition to the light-emitting section 20, an insulating layer 14 and an element isolation layer 15 are provided between the counter substrate 19 and the substrate 13. The light-emitting section 20, the insulating layer 14, and the element isolation layer 15, as described above, are covered with a protective layer 16. The display 1 is one example of the so-called top emission type displays from which light is extracted through the counter substrate 19. A color filter (CF) layer 17 and a reflecting section 18 are formed on a surface of the counter substrate 19 which faces the substrate 13. Transistors (or a write transistor Tr1 and a drive transistor Tr2) that drive the light-emitting section 20 are formed in the substrate 13. A rear surface (surface S2) of the substrate 13 is secured to a support member 11, and a multilayered wiring layer 12 is provided between the substrate 13 and the support member 11.

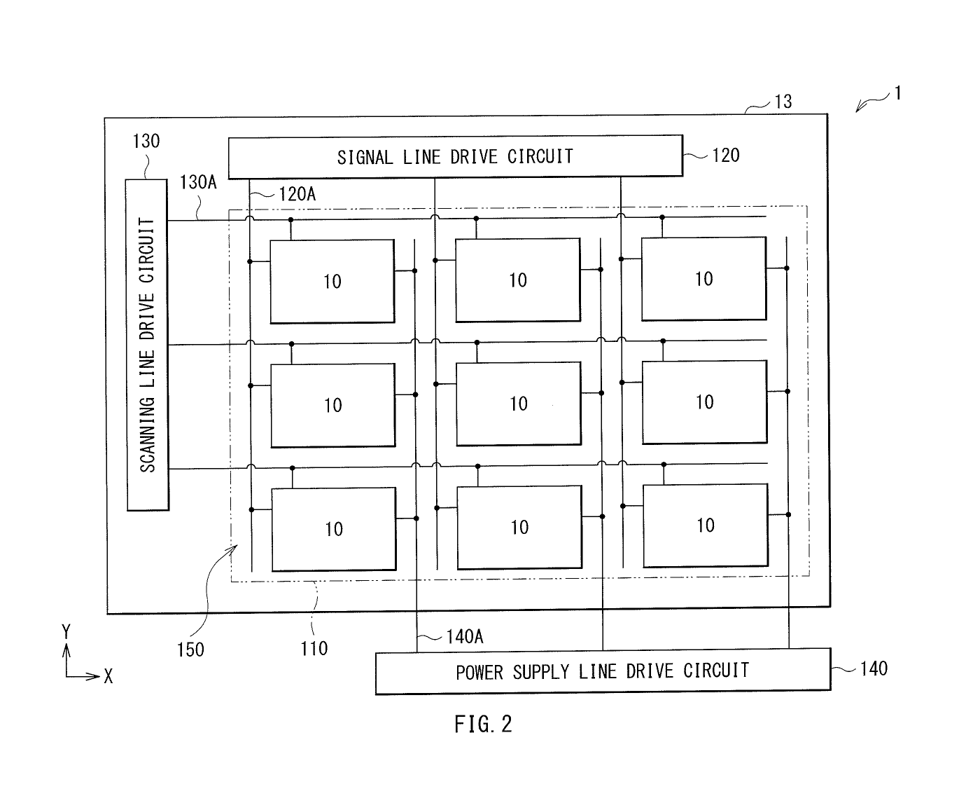

FIG. 2 illustrates an overall configuration of the display 1. The display 1 has a display region 110 in the center of the substrate 13, and may be used, for example, as an ultrathin organic luminescence color display. Provided around the display region 110 are, for example, a signal line drive circuit 120, a scanning line drive circuit 130, and a power supply line drive circuit 140 that serve as drivers for image display.

A plurality of pixels 10 and a pixel drive circuit 150 are formed within the display region 110; the pixels 10 are arranged two-dimensionally in a matrix fashion, and the pixel drive circuit 150 drives the individual pixels 10. For example, each pixel 10 may have the single light-emitting section 20 which may emit, for example, either one of red, green, and blue light beams or all of them. In the pixel drive circuit 150, a plurality of signal lines 120A (120A1, 120A2, . . . 120 Am, and so on) and a plurality of power supply lines 140A (140A1, . . . 140An, and so on) are arranged in a column direction (Y direction), whereas a plurality of scanning lines 130A (130A1, . . . 130An, and so on) are arranged in a line direction (X direction). The respective pixels 10 are provided at the crossings of the signal lines 120A and the scanning lines 130A. The both ends of each signal line 120A are connected to the signal line drive circuit 120; the both ends of each scanning line 130A are connected to the scanning line drive circuit 130; and the both ends of each power supply line 140A are connected to the power supply line drive circuit 140.

The signal line drive circuit 120 applies a signal voltage of an image signal to the selected pixels 10 through the signal lines 120A in accordance with luminance information supplied from a signal supply source (not illustrated). The scanning line drive circuit 130 may be configured with, for example, a shift register that sequentially shifts (transmits) start pulses in synchronization with an input clock pulse. When the image signal is written into each pixel 10, the scanning line drive circuit 130 sequentially supplies scanning signals to the scanning lines 130A while scanning the pixels 10 on a row basis. The signal voltage from the signal line drive circuit 120 is applied to the signal lines 120A, whereas the scanning signals from the scanning line drive circuit 130 are supplied to the scanning lines 130A.

The power supply line drive circuit 140 may be configured with, for example, a shift register that sequentially shifts (transmits) start pulses in synchronization with an input clock pulse. The power supply line drive circuit 140 applies either of a first potential and a second potential, which differ from each other, to each power supply line 140A from the both ends thereof as appropriate, in synchronization with the scanning performed on a column basis by the signal line drive circuit 120. In this manner, either of conductive and non-conductive states of the drive transistor Tr2, which will be described later, is selected.

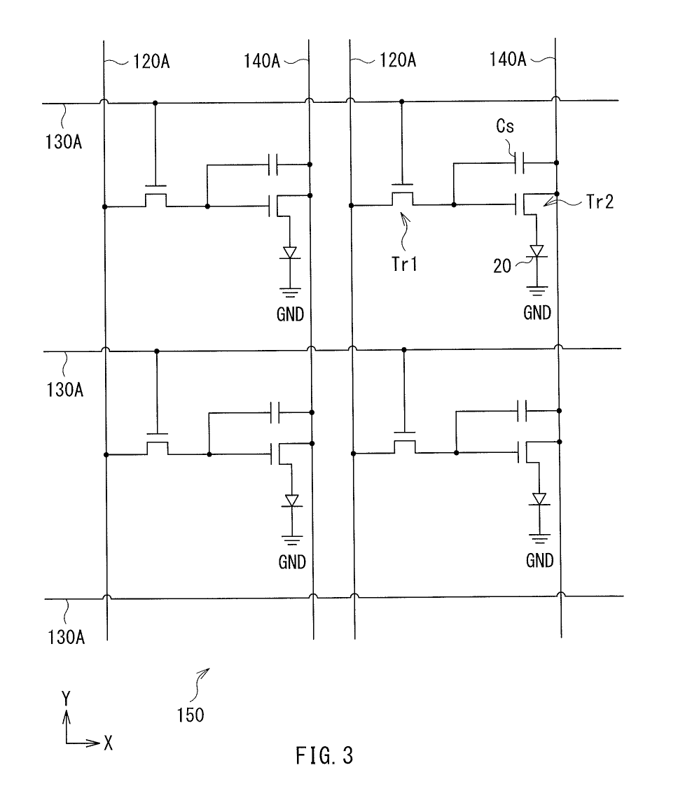

The pixel drive circuit 150 is provided in both the substrate 13 and the multilayered wiring layer 12. FIG. 3 illustrates an exemplary configuration of the pixel drive circuit 150. The pixel drive circuit 150 serves as active drive circuits, each of which includes the write transistor Tr1, the drive transistor Tr2, a capacitor (retention volume) Cs disposed between the two transistors, and the light-emitting section 20. The light-emitting section 20 is connected to the drive transistor Tr2 in series between the power supply line 140A and a common power supply line (GND). The write transistor Tr1 and the drive transistor Tr2 each may be, for example, a silicon thin film transistor (TFT), and employ, for example, either of an inverted stagger structure (so-called bottom gate type) and a stagger structure (so-called top gate type).

For example, a drain electrode of the write transistor Tr1 is connected to the signal line 120A, and is supplied with the image signal from the signal line drive circuit 120. A gate electrode of the write transistor Tr1 is connected to the scanning line 130A, and is supplied with the scanning signal from the scanning line drive circuit 130. A source electrode of the write transistor Tr1 is connected to a gate electrode of the drive transistor Tr2.

For example, a drain electrode of the drive transistor Tr2 is connected to the power supply line 140A, and its potential is set to either of the first or second potential by the power supply line drive circuit 140. A source electrode of the drive transistor Tr2 is connected to the light-emitting section 20.

The retention volume Cs is formed between the gate electrode of the drive transistor Tr2 (or the source electrode of the write transistor Tr1) and the drain electrode of the drive transistor Tr2.

(Configuration of Main Section of Display)

Details of the respective configurations of the substrate 13, the light-emitting section 20, the counter substrate 19, and the like will be described, with reference to FIG. 1 again.

The substrate 13 includes a silicon layer (Si layer) 13A and an insulating layer 13B, and for example, the Si layer 13A and the insulating layer 13B configure the surfaces 51 and surface S2, respectively. The support member 11 holding the substrate 13 may be made of silicon, for example. The Si layer 13A of the substrate 13 is provided with source-and-drain regions 131A and 131B of the write transistor Tr1 and source-and-drain regions 132A and 132B of the drive transistor Tr2. The source-and-drain regions 131A and 131B of the write transistor Tr1 and the source-and-drain regions 132A and 132B of the drive transistor Tr2 each may be, for example, a P-type region provided in an N-type semiconductor well region (hereinafter, referred to as an N-type well region; this equally applies to a P-semiconductor region) 133 in the vicinity of a rear surface (facing the surface S2 of the substrate 13) of the Si layer 13A. Both a gate electrode TG1 of the write transistor Tr1 and a gate electrode TG2 of the drive transistor Tr2 are provided on the rear surface of the Si layer 13A through a gate insulating film (not illustrated). The gate electrodes TG1 and TG2 may be made of, for example, a metal simple substance such as platinum (Pt), titanium (Ti), ruthenium (Ru), molybdenum (Mo), copper (Cu), tungsten (W), nickel (Ni), aluminum (Al), or tantalum (Ta), or an alloy containing one or more of such metals. An insulating sidewall (SW) is provided around these metals.

The insulating layer 13B has conductive plugs 13W1, 13W2, 13W3, 13W4, and 13W5, through which the write transistors Tr1 and the drive transistor Tr2 are electrically connected to wires 121 and 122 in the multilayered wiring layer 12. Each of the conductive plugs 13W1, 13W2, 13W3, 13W4, and 13W5 is a conductor provided in a connection hole of the insulating layer 13B. The wire 122 is connected to, for example, the conductive plugs 13W2 and 13W4, so that the source-and-drain region 131A of the write transistor Tr1 is electrically connected to the gate electrode TG2 of the drive transistor Tr2. The source-and-drain regions 132B of the drive transistor Tr2 is electrically connected to the conductive plug 13W3, and the conductive plug 13W3 is electrically connected to, for example, the power supply line 140A. The source-and-drain region 132A of the drive transistor Tr2 is electrically connected to the wire 121 through the conductive plug 13W5. An electrode (penetrating electrode 13V) which penetrates both the substrate 13 and the insulating layer 14 is provided outside the N-type well region 133. The penetrating electrode 13V electrically connects the wire 121 to the light-emitting section 20 (or a first electrode 21 that will be described later), namely, connects the source-and-drain region 132A of the drive transistor Tr2 to the light-emitting section 20. The penetrating electrode 13V may be formed, for example, by providing a conductive material, such as polysilicon (Poly Si) or tungsten (W), in the hole formed across both the insulating layer 14 and the substrate 13.

In this embodiment, a light-receiving section 30 that receives part of light generated by the light-emitting section 20 is provided within the display region 110 (FIG. 2), and is disposed at a location adjoining both the write transistor Tr1 and the drive transistor Tr2. This enables the light-emitting section 20 and the light-receiving section 30 to be positioned close to each other. Details of this will be described later. It is thus possible to suppress the decrease in the amount of light traveling from the light-emitting section 20 to the light-receiving section 30, thereby increasing the sensitivity of the light-receiving section 30.

The light-receiving section 30 may be configured with, for example, a photodiode, and includes a P-type well region 134 in the vicinity of the rear surface of the Si layer 13A and an N-type region in the P-type well region 134. In short, the light-receiving section 30 is formed in the interior of the substrate 13. The light-receiving section 30 may be provided for each pixel 10, for example. A gate electrode TG3 of a transistor Tr3 is provided on the rear surface of the Si layer 13A through a gate insulating film (not illustrated). The transistor Tr3 carries signal electric charges in the light-receiving section 30 to a floating region FD. The floating region FD may be an N-type region in the P-type well region 134, for example. Conductive plugs 13W6 and 13W7 of the insulating layer 13B are connected to the floating region FD and the gate electrode TG of the transistor Tr3, respectively.

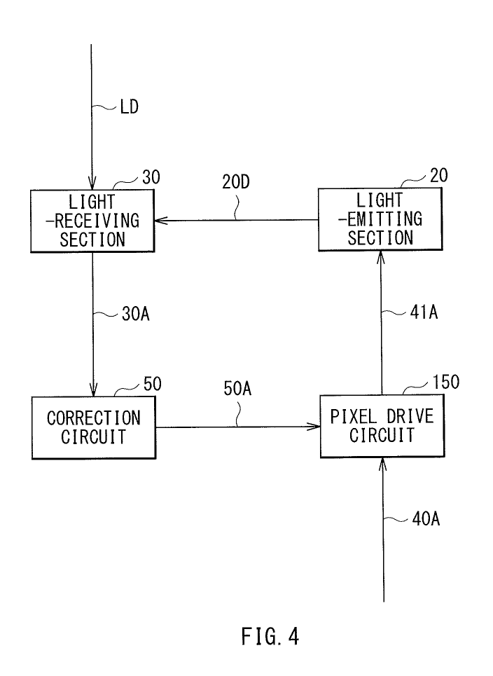

As illustrated in FIG. 4, the light-receiving section 30 detects information (luminescence information 20D) regarding the amount of the light from each light-emitting section 20 (each pixel 10), and acquires information regarding the amount of external light (external light information LD). The light-receiving section 30 then sends a photoelectrically-converted light-receiving signal 30A to the correction circuit 50. The correction circuit 50 calculates a luminescence intensity resulting only from the lighting condition of the light-emitting section 20 by removing the influence of the external light from the light-receiving signal 30A. The correction circuit 50 then outputs a correction signal 50A according to the light amount of each pixel 10 to the pixel drive circuit 150. The pixel drive circuit 150 performs a process of adding the correction signal 50A to an image signal 40A received from the exterior. The pixel drive circuit 150 then outputs a corrected image signal 41A acquired through the above process to each light-emitting section 20 (each pixel 10). As a result, it is possible to control the applied voltage and supplied current for the light-emitting section 20, thereby suppressing the luminance nonuniformity of the light from the light-emitting sections 20.

The light-emitting section 20 is disposed within a predetermined region of the insulating layer 14 provided throughout the surface S1 of the substrate 13. The light-emitting section 20 has the first electrode 21, an organic layer 22 containing a light-emitting layer, and a second electrode 23 in this order with respect to the substrate 13 (insulating layer 14).

The first electrode 21 is provided for each pixel 10 (each light-emitting section 20), and the plurality of first electrodes 21 are arranged on the insulating layer 14 while being separated from one another. The first electrode 21 has functions of an anode and a reflective layer, and may be desirably made of a highly reflective and highly hole-injecting material. A thickness, along a stacked direction (hereinafter, referred to simply as a thickness), of the first electrode 21 configured above may fall within, for example, a range from 30 nm to 1000 nm, and a material thereof may be, for example, a metal simple substance such as chromium (Cr), gold (Au), platinum (Pt), nickel (Ni), copper (Cu), molybdenum (Mo), tungsten (W), titanium (Ti), tantalum (Ta), aluminum (Al), or silver (Ag), or an alloy containing one or more of such metals. Alternatively, the first electrode 21 may be formed by stacking these metal films. Preferably the first electrode 21 (light-emitting section 20) may be disposed directly above both the write transistor Tr1 and the drive transistor Tr2 (or the N-well region 133 in the substrate 13), so as to overlap them in planar view. The first electrode 21 disposed in this manner blocks external light which would enter the write transistor Tr1 and the drive transistor Tr2. This makes it possible to prevent the operating points of the write transistor Tr1 and the drive transistor Tr2 from being changed by light.

The element isolation layer 15 covers the side of the first electrode 21 from the surface thereof (facing the second electrode 23), and provides the element isolation layer 15 with an opening that defines a luminescence region of the light-emitting section 20. The surface of the first electrode 21 is thus exposed through the opening of the element isolation layer 15. The element isolation layer 15 has functions of controlling the light-emitting region accurately in such a way that it has a desired shape, and reliably isolating the first electrode 21 from the second electrode 23 and the light-emitting section 20 from the adjacent light-emitting sections 20. The insulating layer 14 and the element isolation layer 15 each may be made of, for example, an organic material such as polyimide, or an inorganic material such as oxidization silicon (SiO₂), nitriding silicon (SiNx), or oxynitriding silicon (SiON). For example, the insulating layer 14 may have a thickness of 100 nm to 1000 nm, and the element isolation layer 15 may have a thickness of 50 nm to 2500 nm.

The organic layer 22 includes, for example, a hole injection layer, a hole transportation layer, a light-emitting layer, an electron transport layer, and an electron injection layer (all not illustrated) in this order with respect to the first electrode 21. The organic layer 22 may be either shared by all the light-emitting sections 20 or provided for each light-emitting section 20.

The hole injection layer increases an efficiency of injecting holes, and serves as a buffer layer that prevents a leak current. For example, a thickness of the hole injection layer may fall within a range from 1 nm to 300 nm, and a material thereof may be, for example, a hexaazatriphenylene derivative, which is represented by a chemical formula 1 or 2.

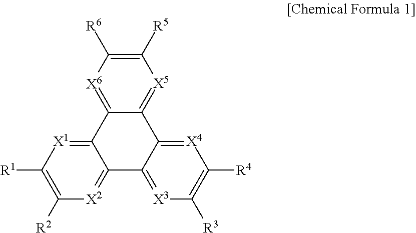

(In the chemical formula 1, R1 to R6 are substituent groups independently selected from: hydrogen; halogen; a hydroxyl group; an amino group; an aryl amino group; a substituent or non-substituent carbonyl group having a carbon number of 20 or less; a substituent or non-substituent carbonyl ester group having a carbon number of 20 or less; a substituent or non-substituent alkyl group having a carbon number of 20 or less; a substituent or non-substituent alkenyl group having a carbon number of 20 or less; a substituent or non-substituent alkoxyl group having a carbon number of 20 or less; a substituent or non-substituent aryl group having a carbon number of 30 or less; a substituent or non-substituent heterocyclic group having a carbon number of 30 or less; a nitrile group; a cyano group; a nitro group; and a silyl group. Adjoining Rm (m=1 to 6) may be mutually bonded through an annular structure. X1 to X6 are independently carbons or nitrogen atoms.)

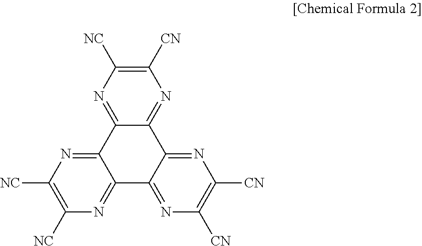 [SMILES: N#Cc1nc2c3nc(C#N)c(C#N)nc3c3nc(C#N)c(C#N)nc3c2nc1C#N]

The hole transportation layer increases an efficiency of transporting holes to the light-emitting layer. For example, a thickness of the hole transportation layer may be about 40 nm, and a material thereof may be, for example, 4,4′,4″-tris (3-methylphenylphenylamino)triphenylamine (m-MTDATA) or α-naphthylphenyl diamine (αNPD).

The light-emitting layer emits, for example, white light, and has a stack made up of, for example, red, green, and blue light-emitting layers (all not illustrated) between the first electrode 21 and the second electrode 23. Any one of the red, green, and blue light-emitting layers may be provided for each light-emitting section 20. When an electric field is applied to the red, green, and blue light-emitting layers, some of holes injected from the first electrode 21 through the hole injection layer and the hole transportation layer are recombined with some of electrons injected from the second electrode 23 through the electron injection layer and the electron transport layer. As a result, the red, green, and blue light-emitting layers generate red light, green light, and blue light, respectively.

The red light-emitting layer may contain, for example, one or more of a material that emits red light, a material that transports holes, a material that transports electrons, and a material that transports both holes and electrons. The red light-emitting layer may be made of either of fluorescent and phosphorescent materials. For example, a thickness of the red light-emitting layer may be about 5 nm, and it may be formed by mixing 30 wt % of 2,6-bis[(4′-methoxy diphenylamino)styryl]-1,5-dicyano naphthalene (BSN) in 4,4-bis(2,2-diphenyl vinyl)biphenyl (DPVBi).

The green light-emitting layer may contain, for example, one or more of a material that emits green light, a material that transports holes, a material that transports electrons, and a material that transports both holes and electrons. The green light-emitting layer may be made of either of fluorescent and phosphorescent materials. For example, a thickness of the green light-emitting layer may be about 10 nm, and a material thereof may be formed by mixing 5 wt % of Kumarin 6 in DPVBi.

The blue light-emitting layer may contain, for example, one or more of a material that emits blue light, a material that transports holes, a material that transports electrons, and a material that transports both holes and electrons. The blue light-emitting layer may be made of either of fluorescent and phosphorescent materials. For example, a thickness of the blue light-emitting layer may be about 30 nm, and it may be formed by mixing 2.5 wt % of 4,4′-bis[2-{4-(N,N-diphenylamino)phenyl}vinyl]biphenyl (DPAVBi) in DPVBi.

The electron transport layer increases an efficiency of transporting electrons to the light-emitting layer. The electron transport layer may be made of, for example, 8-hydroxy quinoline aluminum (Alq3) having a thickness of about 20 nm. The electron injection layer increases an efficiency of injecting electrons to the light-emitting layer. The electron transport layer may be made of, for example, LiF or Li₂O having a thickness of about 0.3 nm.

The second electrode 23 is disposed opposite the first electrode 21 with the organic layer 22 therebetween, and pairs up with the first electrode 21. The second electrode 23 is provided, for example, on the electron injection layer so as to be shared by the light-emitting sections 20 (pixels 10) while being insulated with the first electrode 21. The second electrode 23 may be made of, for example, a transparent material that transmits light, and examples of such material may include an alloy containing two of more of aluminum (Al), magnesium (Mg), silver (Ag), calcium (Ca), and sodium (Na). Among them, an alloy of magnesium and silver (Mg—Ag alloy) is preferred, because a thin film made of Mg—Ag alloy exhibits both conductivity and small absorbability. A ratio of magnesium to silver in the Mg—Ag alloy is not limited to a specific ratio; however it is desirable that a film thickness ratio of Mg:Ag fall within, for example, a range from 20:1 to 1:1. A material of the second electrode 23 may also be, for example, an alloy of aluminum (Al) and lithium (Li) (Al—Li alloy). Alternatively a material of the second electrode 23 may be, for example, an indium tin oxide (ITO), a zinc oxide (ZnO), an alumina dope zinc oxide (AZO), a gallium dope zinc oxide (GZO), an indium zinc oxide (IZO), an indium titanium oxide (ITiO), or an indium tungsten oxide (IWO).

The protective layer 16 is provided throughout the surface of the substrate 13 so as to cover the second electrode 23, and may be made of, for example, an insulating resin material such as polyimide. A CF layer 17 is provided on one surface (facing the substrate 13) of the counter substrate 19. The CF layer 17 has a red color filter 17R, a green color filter (not shown), and a blue color filter 17B, and they are arranged side by side in order corresponding to the light-emitting sections 20 (pixels 10). The CF layer 17 may be provided on an either surface of the counter substrate 19; however it is preferably provided on the surface closer to the light-emitting section 20, because this makes it possible to prevent the color filters from being exposed from the surface, and to protect the color filters with the protective layer 16 (or an adhesive layer). Furthermore, a distance between the organic layer 22 and each color filter decreases, thereby preventing a light beam emitted from the organic layer 22 from entering the other adjacent color filters for different colors, namely, preventing the light beams of different colors from being combined.

The reflecting section 18 reflects part of light emitted from the light-emitting section 20 toward the counter substrate 19, thus collecting light to the light-receiving section 30 in the substrate 13. The reflecting section 18 may be provided, for example, in a region facing the light-receiving section 30 for each pixel 10. The reflecting section 18 may be a highly reflective metal film made of, for example, aluminum, tungsten, silver, or titanium. In addition, the reflecting section 18 may also be formed by stacking an oxide or nitride such as titanium nitride (TiN) on the above-mentioned metal. The reflecting section 18, which may be formed by stacking titanium nitride and aluminum in this order with respect to the counter substrate 19, is able to suppress light from being reflected on a display surface thereof. In turn, the reflecting section 18 is able to reflect the light from the light-emitting section 20 efficiently, thereby causing this light to enter the light-receiving section 30. In addition to the reflecting section 18, a light-shielding part (not illustrated) that prevents a light leak between the adjacent pixels 10 may be provided. For example, the reflecting section 18 made of aluminum and the light-shielding part made of titanium nitride may be stacked. The counter substrate 19 seals the light-emitting section 20 together with the adhesive layer (not illustrated) such as a thermosetting resin. The counter substrate 19 may be made of, for example, a transparent glass or plastic material that transmits light generated by the organic layer 22.

(Method of Manufacturing Display)

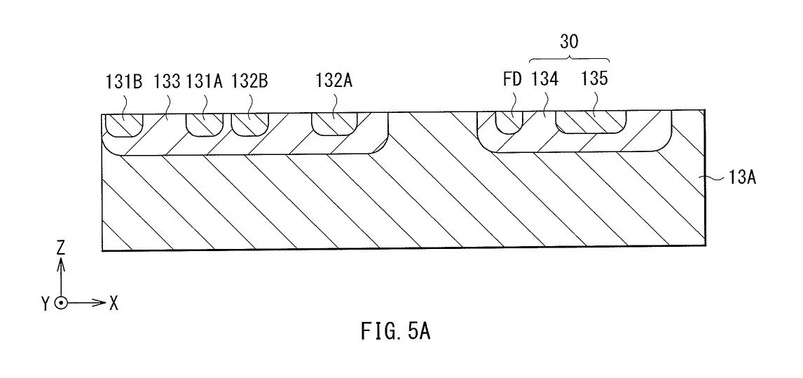

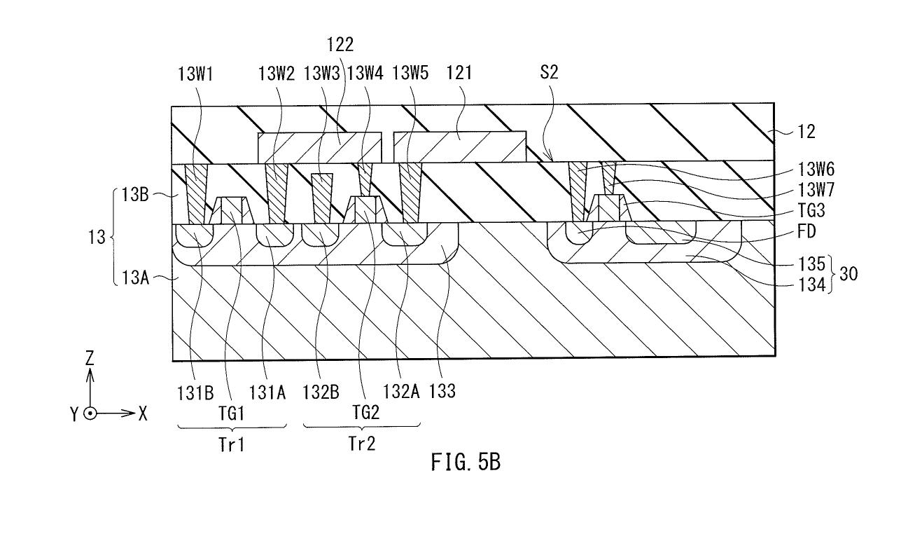

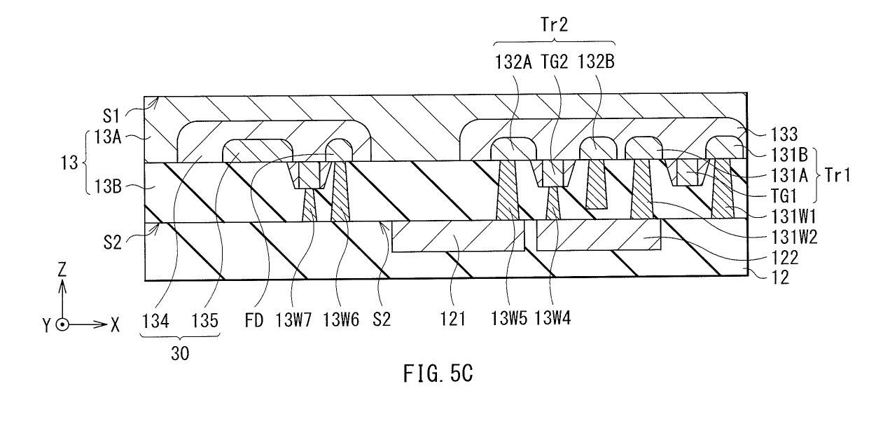

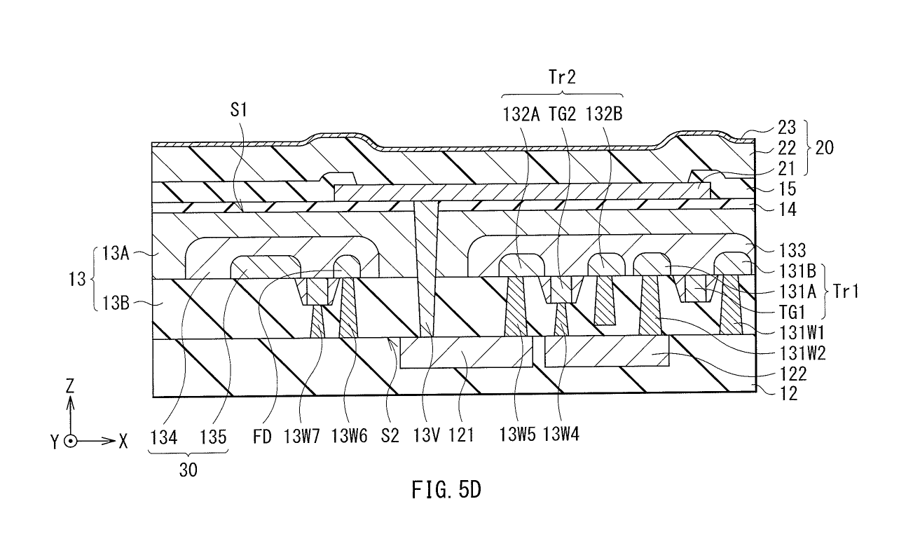

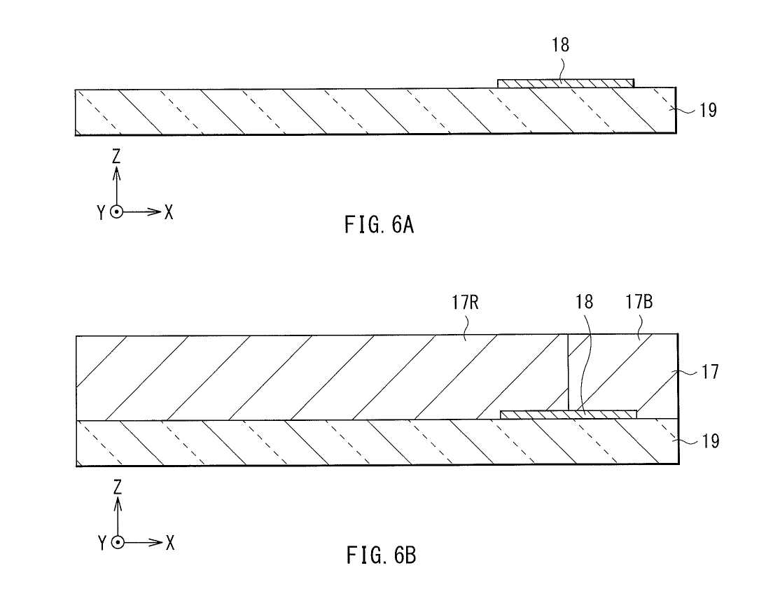

The display 1 configured above may be manufactured, for example through processing described below (see FIGS. 5A to 6B).

First, the substrate 13 is formed. In more detail, first, the N-type well region 133, the source-and-drain regions 131A and 131B of the write transistor Tr1, the source-and-drain regions 132A and 132B of the drive transistor Tr2, the P-type well region 134, the N-type region 135, and the floating region FD are formed in the vicinity of a surface of the Si layer 13A by, for example, ion implantation (see FIG. 5A). In this case, the Si layer 13A may be a SOI (Silicon On Insulator) board, for example. Then, the gate electrode TG1 of the write transistor Tr1, the gate electrode TG2 of the drive transistor Tr2, and the gate electrode TG3 of the transistor Tr3 are formed, through the gate insulating film (not illustrated), on the surface of the Si layer 13A in which the above impurity diffusion regions are provided. The gate electrodes TG1, TG2, and TG3 may be formed by forming a conductive film, for example, by a chemical vapor deposition (CVD) method and subsequently subjecting the conductive film to dry etching. After that, the insulating layer 13B is formed so as to cover the gate electrodes TG1, TG2, and TG3. Through the above processing, the substrate 13 is formed. In this case, the conductive plugs 13W1, 13W2, 13W3, 13W4, 13W5, 13W6, and 13W7 are provided in the insulating layer 13B. After the formation of the substrate 13, the multilayered wiring layer 12 (wires 121 and 122) is formed on the insulating layer 13B of the substrate 13 (or on the surface S2 of the substrate 13) (see FIG. 5B).

Then, after the support member 11 (see FIG. 1) is bonded to the multilayered wiring layer 12, all of the support member 11, the multilayered wiring layer 12, and the substrate 13 are placed in an inverted position. The other surface (or a surface opposite the formation surface of the N-type well region 133, the P-type well region 134, and the like) of the Si layer 13A is polished by, for example, chemical mechanical polishing (CMP) so that the Si layer 13A has a desired thickness (FIG. 5C). This polished surface becomes the surface 51 of the substrate 13. In this case, for example, before the CMP is performed, the other surface of the Si layer 13A may be roughly polished by a grinder, and after the CMP process finishes, the Si layer 13A may be planarized using a chemical solution such as hot phosphoric acid. After the Si layer 13A is polished, the insulating layer 14 is formed on the surface 51 of the substrate 13, and the penetrating electrode 13V is then formed in the substrate 13. The penetrating electrode 13V may be formed by, for example, providing a hole across both the insulating layer 14 and the substrate 13, embedding a conducting material in this hole, and performing the CMP.

Then, for example, an aluminum film is formed on the insulating layer 14 by a sputtering method, and this aluminum film is patterned through a photolithography process, so that the first electrode 21 is formed. Subsequently, for example, a silicon nitride film is formed on both the first electrode 21 and the insulating layer 14, for example, by a plasma CVD method, and an opening is provided in this nitriding silicon film, so that the element isolation layer 15 is formed. STI (shallow trench isolation) may be employed to form the element isolation layer 15.

After the provision of the element isolation layer 15, the second electrode 23 and the organic layer 22 containing the light-emitting layer are formed, for example, by a vapor-depositing method (see FIG. 5D). After the light-emitting section 20 is provided in this manner, the protective layer 16 is formed on the light-emitting section 20, for example, by the CVD or sputtering method.

On the other hand, the reflecting section 18 and the CF layer 17 are formed on a surface of the counter substrate 19, for example, in this order (see FIGS. 6A and 6B). Then, a sealing agent is applied to the periphery of the counter substrate 19 provided with the CF layer 17, and is bonded to the substrate 13 provided with the protective layer 16. Finally, a filler is injected to a gap between the substrate 13 and the counter substrate 19, and this gap is then sealed. Through the above processing, the display 1 may be completed.

(Operation of Display)

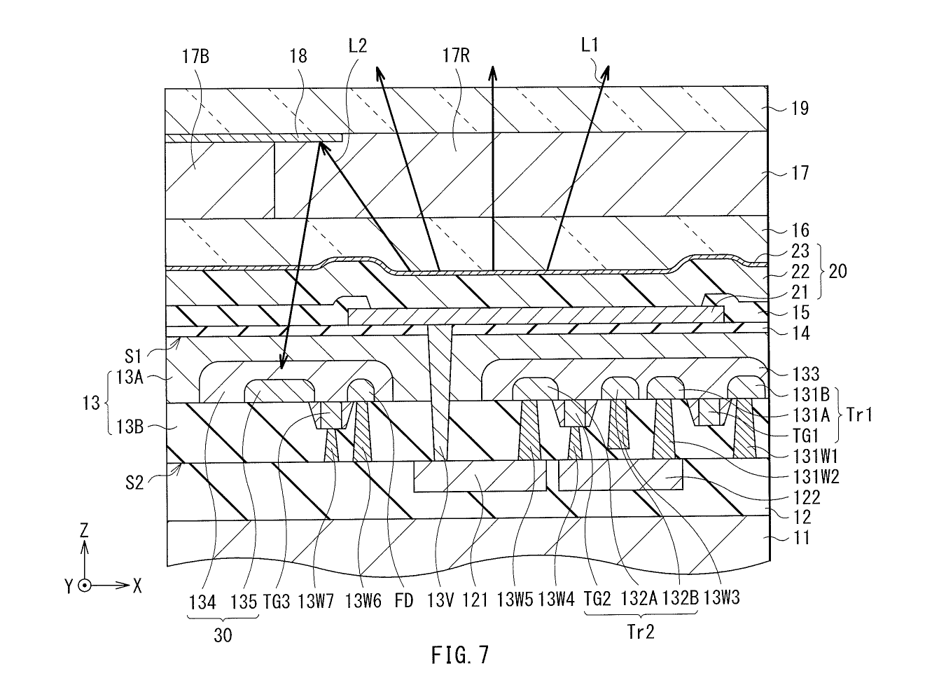

In the display 1 configured above, the scanning line drive circuit 130 supplies a scanning signal to each pixel 10 through the gate electrode TG1 of the write transistor Tr1. An image signal from the signal line drive circuit 120 is held in the retention volume Cs through the write transistor Tr1. Specifically, the turn-on/off of the drive transistor Tr2 is controlled depending on the signal held in the retention volume Cs. A driving current Id is thereby injected into each light-emitting section 20, and holes and electrons are recombined therein. Consequently, each pixel 10 emits light. As illustrated in FIG. 7, light (light L1) is extracted from the display 1 after passing through the second electrode 23, the CF layer 17, and the counter substrate 19.

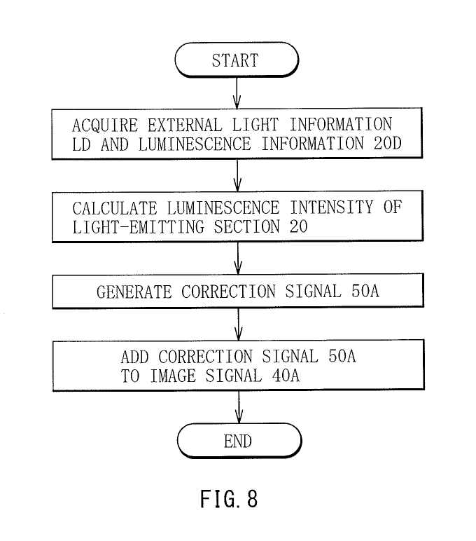

Part (light L2) of light generated by the light-emitting section 20 is reflected by the reflecting section 18, and then enters the light-receiving section 30 of the substrate 13. When the correction circuit 50 receives the light-receiving signal 30A (FIG. 4) from the light-receiving section 30, the correction circuit 50 may send the correction signal 50A to the pixel drive circuit 150, for example, in the following manner (see FIG. 8). First, the light-receiving section 30 is driven in respective occasions where the light-emitting section 20 is on to emit light and where the light-emitting section 20 is off so as not to emit light, and acquires both the external light information LD and the luminescence information 20D. Preferably the light-receiving section 30 may be initialized before being driven. Both the external light information LD and the luminescence information 20D that the light-receiving section 30 has detected are converted into digital signals by an analog to digital converter (ADC), and are stored. For example, the light-emitting section 20 may be off during these digital conversion and storage processes. The correction circuit 50 calculates the luminescence intensity of each pixel 10 resulting only from the light-emitting section 20, by subtracting the digital data of the external light information LD from the digital data of the luminescence information 20D. Subsequently, the correction circuit 50 generates the correction signal 50A according to the luminance of each pixel 10 by comparing the respective lighting conditions of each pixel 10 and a target pixel. For example, correction circuit 50 may be updated by new correction information at this timing. The pixel drive circuit 150 adds the correction signal 50A to the image signal 40A converted by the digital to analog converter (DAC), and sends the corrected image signal 41A to the light-emitting section 20. The acquisition of the correction signal 50A does not necessarily have to follow the image output. For example, the correction signal 50A may be acquired once in every 60 frames in the image output. Alternatively the correction signal 50A may be acquired at the time of turn-on/off of the power supply. The light-emitting section 20 and the correction circuit 50 may operate as appropriate, depending on the update timing of the correction information. If the light amounts indicated by the external light information LD and the luminescence information 20D exceed that of the light-receiving section 30, the display 1 may be set to detect an error, or perform the operation of receiving light again. The ADC and DAC may be built into the correction circuit 50, or provided outside the correction circuit 50.

(Function and Effect of Display)

In the present embodiment, providing the light-receiving section 30 within the display region 110 decreases the distance between the light-emitting section 20 and the light-receiving section 30. This enables the light-receiving section 30 to detect the light from the light-emitting section 20 accurately with high sensitivity. It is thus possible to suppress the luminance nonuniformity effectively. This function and effect will be described below.

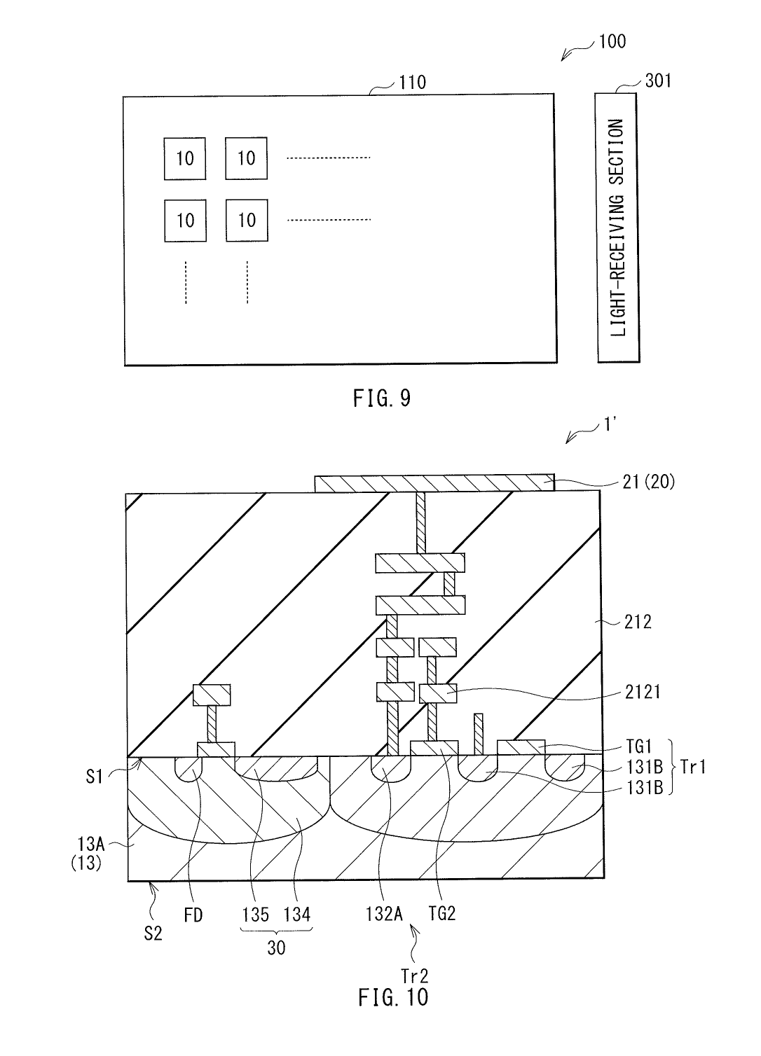

FIG. 9 schematically illustrates a planar configuration of a display (display 100) according to a comparative example. In the display 100, a light-receiving section 301 is disposed within a region outside a display region 110. Because of this arrangement, a distance between each pixel 10 (light-emitting section) and the light-receiving section 301 increases. Furthermore, since the distances between the respective pixels and the light-receiving section 301 differ from one another, it is necessary for a correction circuit to consider the attenuation of the light, depending on a distance between each pixel and the light-receiving section 301, in addition to the deterioration of the light-emitting sections.

A method of capturing an image on a display by using an external image pickup device is proposed, as a method of suppressing luminance nonuniformity (for example, refer to Japanese Unexamined Patent Application Publication No. 2011-77825). However an accuracy with which an image is captured depends on an operator. It is therefore difficult to detect the light from the light-emitting section accurately. In addition, using a plurality of transistors and capacitors in combination also makes it possible to adjust the variations in the performances of transistors that drive pixels (for example, refer to Japanese Unexamined Patent Application Publication No. 2010-145579). This method, however, has difficulty correcting the luminance nonuniformity on the pixels which may be caused by the deterioration of the light-emitting sections. Also, as the spacing between the pixels becomes narrower, the area of each capacitor shrinks, and the capacity therefore becomes more difficult to sufficiently secure.

In contrast, the display 1 is provided with the light-receiving section 30 within the display region 110 (see FIG. 2). Therefore, by disposing the light-receiving section 30 in the interior of the substrate 13 for each light-emitting section 20 (pixel 10), it is possible to decrease the distance between the light-emitting section 20 and the light-receiving section 30. The light-emitting section 20 may be provided directly above the transistors (or the write transistor Tr1 and the drive transistor Tr2) that drive the light-emitting section 20, and the light-receiving section 30 may be disposed for every pixel 10, for example, at a location adjoining these transistors. This decreases the distance between the light-emitting section 20 and the light-receiving section 30 in an in-plane direction (XY plane) of the substrate 13. Therefore, the display 1 is applicable to displays with a small spacing between pixels, such as those having micro organic light emitting diodes (OLEDs).

As illustrated in FIG. 10, it is possible to provide a multilayered wiring layer (multilayered wiring layer 212) on the surface Si of the substrate 13. This arrangement, however, increases the distance between the light-emitting section 20 and the light-receiving section 30 in a vertical direction with respect to the surface (surface S1 or S2) of the substrate 13 (or in a distance along a Z direction). In addition, this arrangement involves a waveguide structure in the multilayered wiring layer 212 which guides the light from the light-emitting section 20 to the light-receiving section 30. For this reason, preferably the light-emitting section 20 is provided on a surface (surface S1) of the substrate 13 and the multilayered wiring layer 12 is provided on a rear surface (surface S2) thereof, in order to decrease the distance between the light-emitting section 20 and the light-receiving section 30 in the vertical direction with respect to the surface of the substrate 13.

As described above, the display 1 in the present embodiment is provided with the light-receiving section 30 within the display region 110, thus being able to decrease the distance between the light-emitting section 20 and the light-receiving section 30. It is therefore possible to suppress the decrease in the amount of light traveling from the light-emitting section 20 to the light-receiving section 30, thereby permitting the light-receiving section 30 to send the light-receiving signal 30A to the correction circuit 50 more accurately. Consequently, the display 1 successfully suppresses the luminance nonuniformity among the pixels 10 within the display region 110.

Hereinafter a modification of the above embodiment and some other embodiments will be described. In the following description, the same reference characters are assigned to the same constituent elements as in the above embodiment, and descriptions thereof will not be described as appropriate.

<Modification 1>

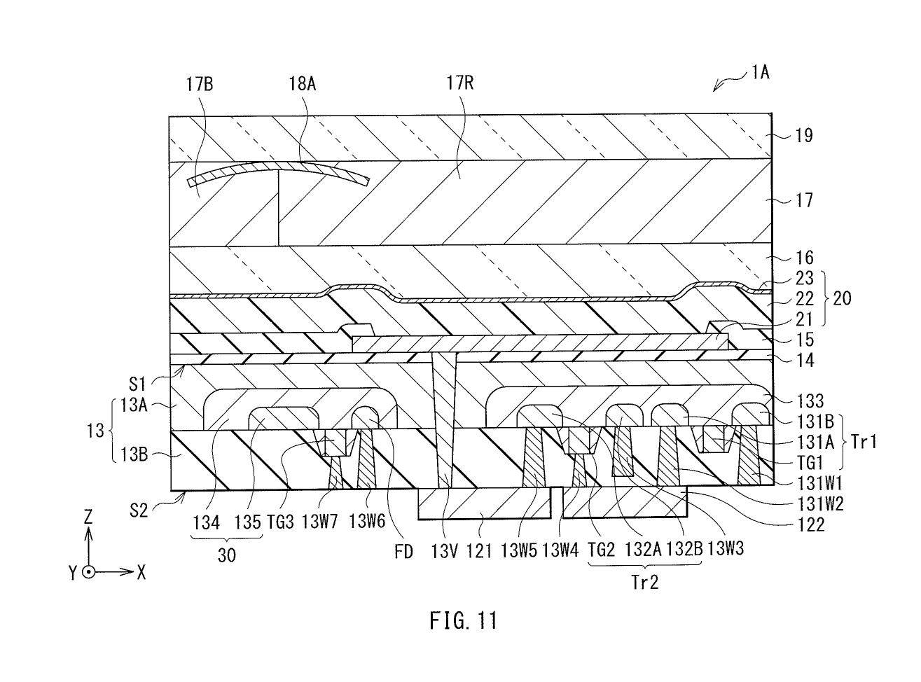

FIG. 11 illustrates a configuration of a cross section of a display (display 1A) according to a modification 1. The display 1A has a reflecting section (reflecting section 18A) in the so-called parabolic shape with its parabolic curved surface facing a counter substrate 13. Except for this, the display 1A has the same configuration as in the display 1, and its function and effect are also the same as those of the display 1.

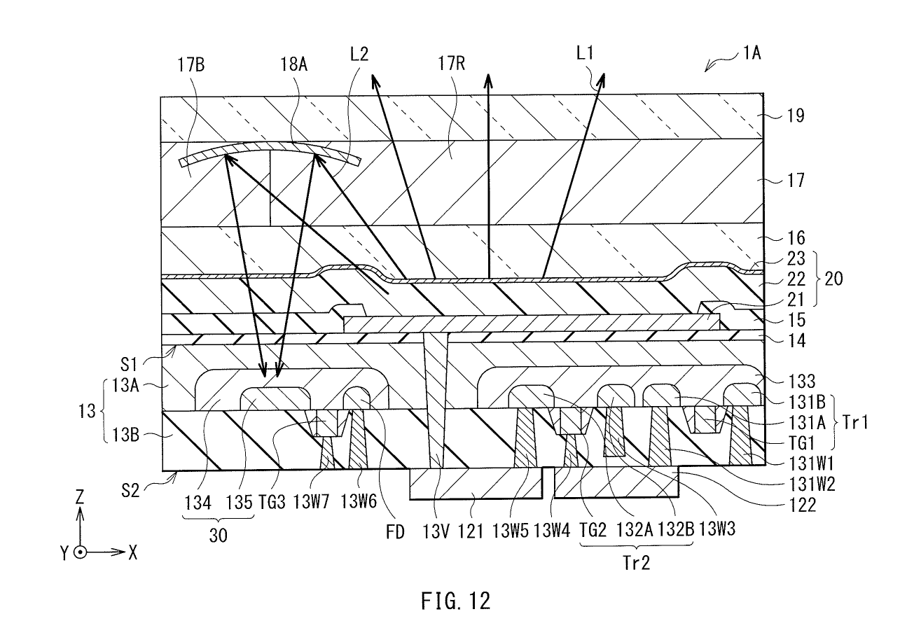

The parabolic curved surface of the reflecting section 18A focuses light on the light-receiving section 30. As illustrated in FIG. 12, light (light L2) which has reached the reflecting section 18A from the light-emitting section 20 is efficiently collected to the light-receiving section 30 from the reflecting section 18A. The reflecting section 18A thus increases the amount of the light entering the light-receiving section 30 from the light-emitting section 20, thereby enabling the luminance of each pixel 10 to be corrected with higher accuracy.

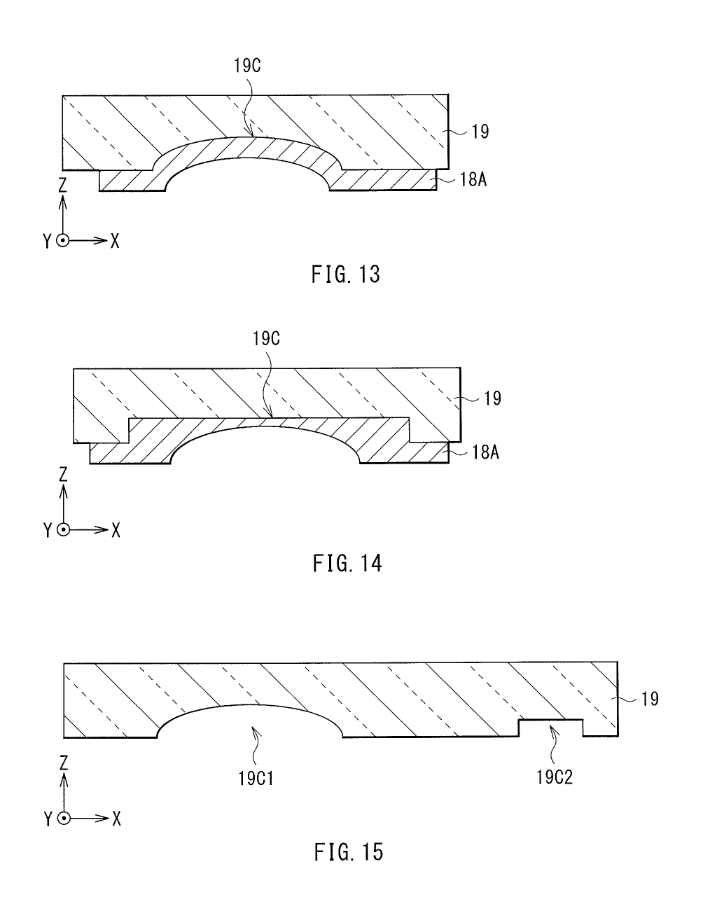

The reflecting section 18A may be formed, for example, through processing described below. First, a depression 19C with a parabolic curved surface is formed within a region of the counter substrate 19 in which the reflecting section 18A is to be formed (FIG. 13). In more detail, after a resist is provided on a surface of the counter substrate 19, a parabolic curved surface is formed in the resist, for example, by adjusting a light exposure during a photolithography process. That is, the resist is molded such that its center becomes thinner and its circumference becomes thicker. The parabolic curved surface of the resist may be formed either using a half-tone mask or through a reflow process. By performing plasma etching using the resist with the above parabolic curved surface, the depression 19C is formed in the counter substrate 19. After the provision of the depression 19C, a highly reflective metal film may be formed throughout the surface of the counter substrate 19. Subsequently, a mask is formed, by a resist, within a region of the metal film in which the reflecting section 18A is to be formed, and then plasma or wet etching is performed. Finally the resist is removed. Through the above processing, the reflecting section 18A is formed. As illustrated in FIG. 14, a metal film may be formed within the rectangular depression 19C in the counter substrate 19, and this metal film then may be grind, for example, by CMP so that the reflecting section 18A is formed. When the reflecting section 18A is formed, preferably a depression 19C2 used for alignment of the reflecting section 18A may be provided in the counter substrate 19, in addition to a depression 19C1 in which the reflecting section 18A is to be provided (see FIG. 15).

### Second Embodiment

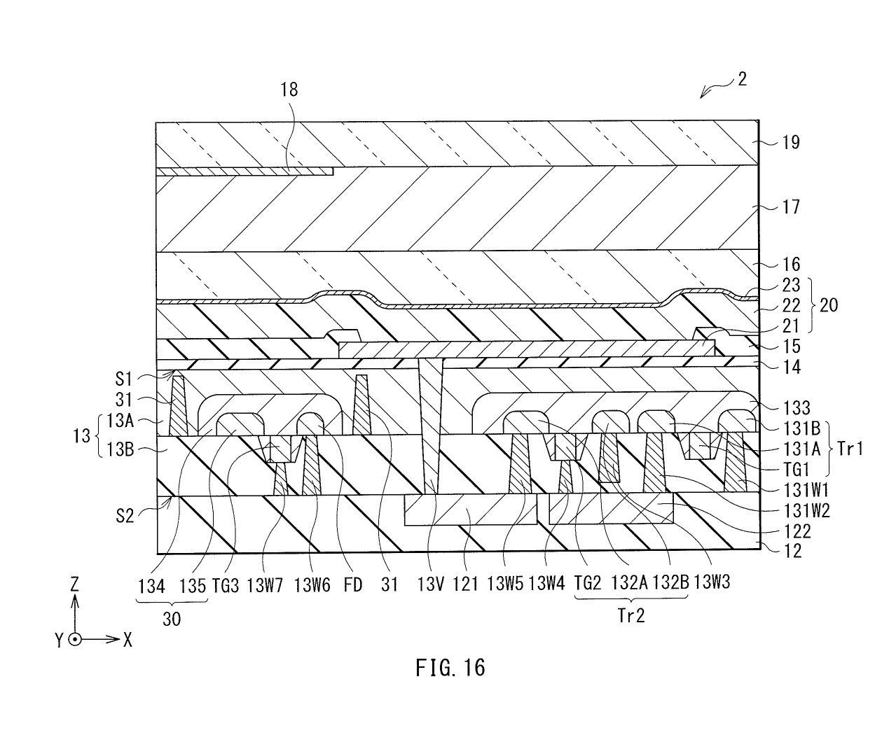

FIG. 16 illustrates a configuration of a cross section of a display (display 2) according to a second embodiment. The display 2 has a shield section (shield section 31) between a light-receiving section 30 and a write transistor Tr1 or the light-receiving section 30 and a drive transistor Tr2. Except for this, the display 2 has the same configuration as in the display 1, and its function and effect are also the same as those of the display 1.

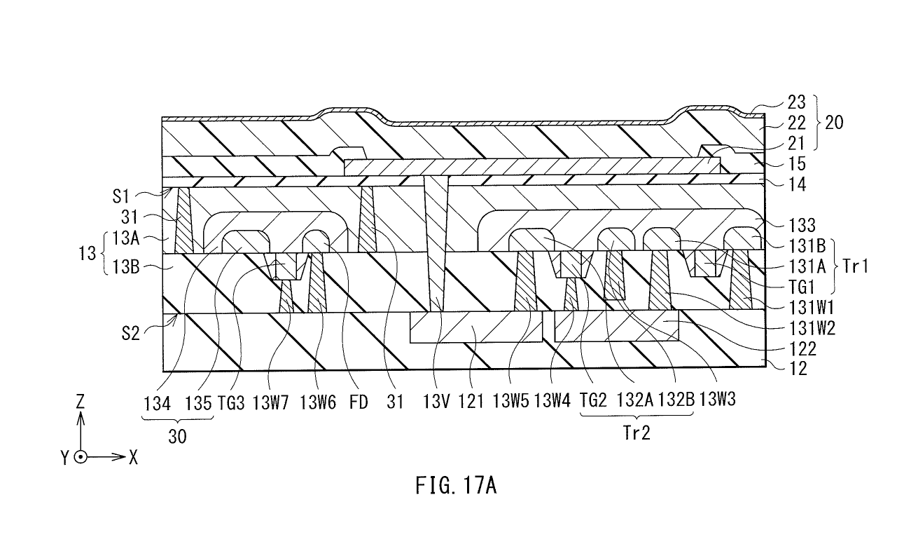

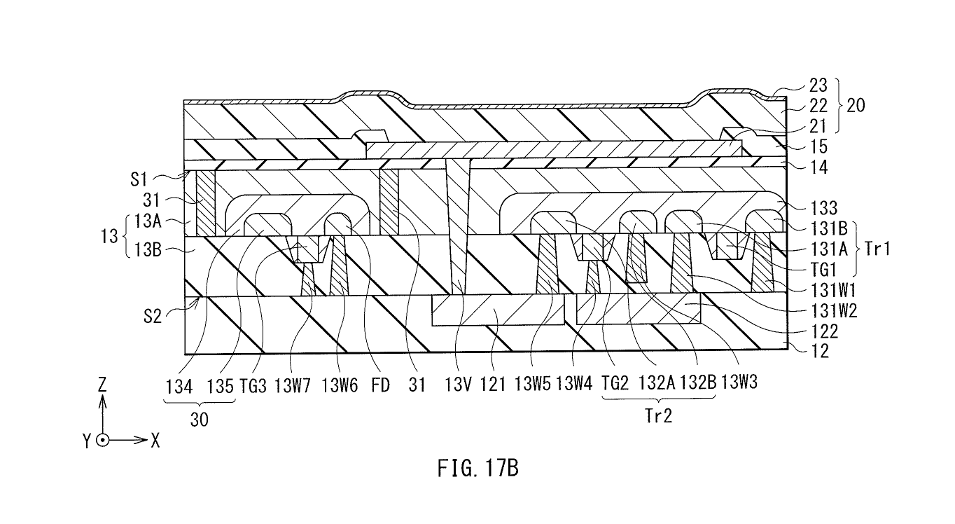

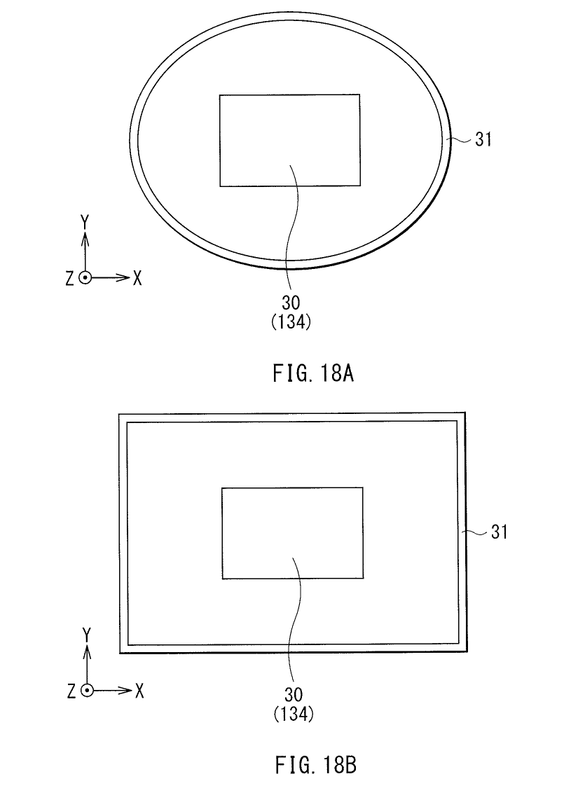

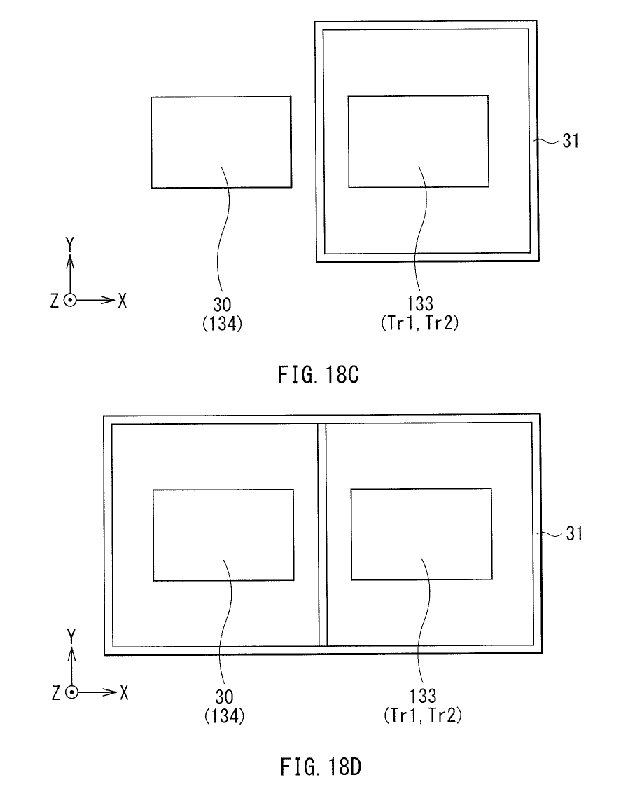

The shield section 31 may be configured with, for example, an insulating film or a metal film provided in a groove of a Si layer 13A; for example, the insulating film may be made of silicon oxide, silicon nitride, or the like, and the metal film may be made of tungsten, titanium, titanium nitride, or the like. Alternatively, the shield section 31 may be formed by stacking an insulating film and a metal film. For example, a silicon oxide film, a silicon nitride film, a titanium film or titanium nitride film, and a tungsten film may be stacked in the groove of the Si layer 13A in this order. It is only necessary to provide the groove of the Si layer 13A so as to have the same depth as the formation regions of the write transistor Tr1, the drive transistor Tr2, and the light-receiving section 30 (see FIG. 16). Alternatively, the groove of the Si layer 13A may be formed so as to pass through the Si layer 13A (see FIG. 17A). The shield section 31 may have either a tapered shape (see FIG. 16) or a columnar shape (see FIG. 17B). The shield section 31 is disposed between an N-type well region 133 in which the write transistor Tr1 and the drive transistor Tr2 are provided and a P-type well region 134 in which the light-receiving section 30 is provided. In addition, the shield section 31 surrounds the light-receiving section 30 (P-type well region 134) (see FIGS. 18A and 18B). The shield section 31 may surround either only the N-type well region 133 (see FIG. 18C) or both the P-type well region 134 and the N-type well region 133 (see FIG. 18D).

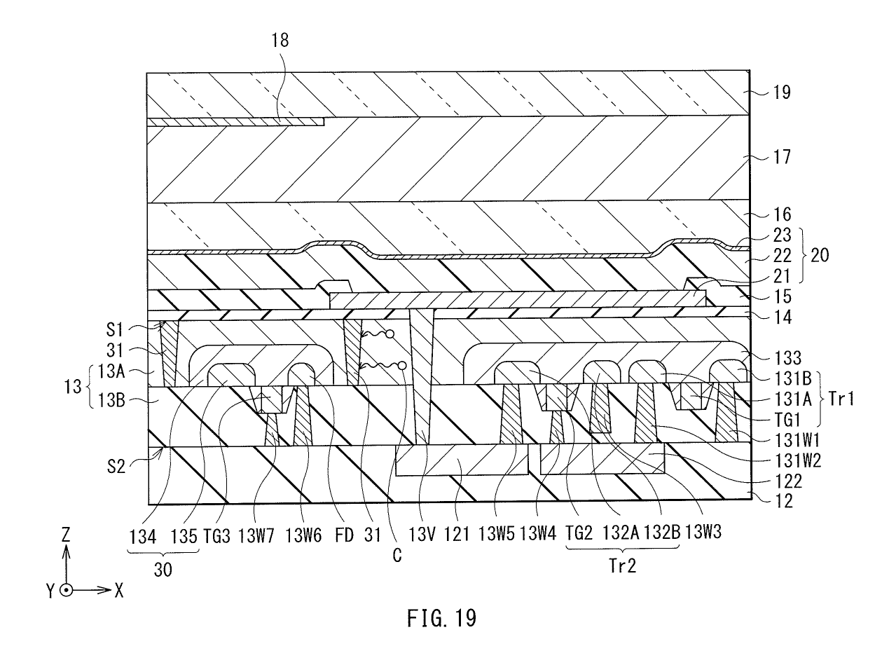

Providing the shield section 31 configured above enables the light-receiving section 30 to detect light from the light-emitting section 20 more accurately. This function and effect will be described below in detail. As illustrated in FIG. 19, the light generated by the light-emitting section 20 increases the temperature of the substrate 13 (Si layer 13A). As a result, extra carriers (carriers C) are generated. In addition, in the case where light which has been reflected by the reflecting section 18 enters the substrate 13, if part of the light enters a site of the substrate 13 other than the light-receiving section 30, extra carriers such as the carriers C are also generated. The shield section 31 prevents the carriers C generated outside the light-receiving section 30 in this manner from entering the light-receiving section 30. Providing the shield section 31 thus blocks the carriers C from entering the light-receiving section 30, so that the light-receiving section 30 detects the light from each light-emitting section 20 more accurately.

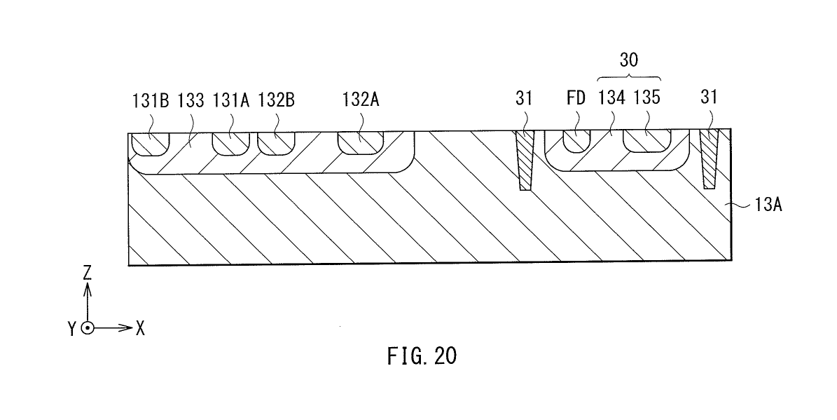

As illustrated in FIG. 20, for example, the shield section 31 may be formed by: providing the light-receiving section 30 (the P-well region 134 and the N-type region 135) and the floating region FD in the Si layer 13A; forming a groove, for example, around the light-receiving section 30; and embedding an insulating film in this groove. After the insulating film is embedded, the Si layer 13A may be polished by the CMP. For example, the shield section 31 may be formed together with a mark (for example, back side alignment (BSA)) used for alignment of the substrate 13 and the counter substrate 19. Alternatively after the Si layer 13A is polished (see FIG. 5C), the shield section 31 configured with the above insulating film or metal film may be formed together with the penetrating electrode 13V. Forming the shield section 31 together with the penetrating electrode 13V provides a simple etching process.

<Modification 2>

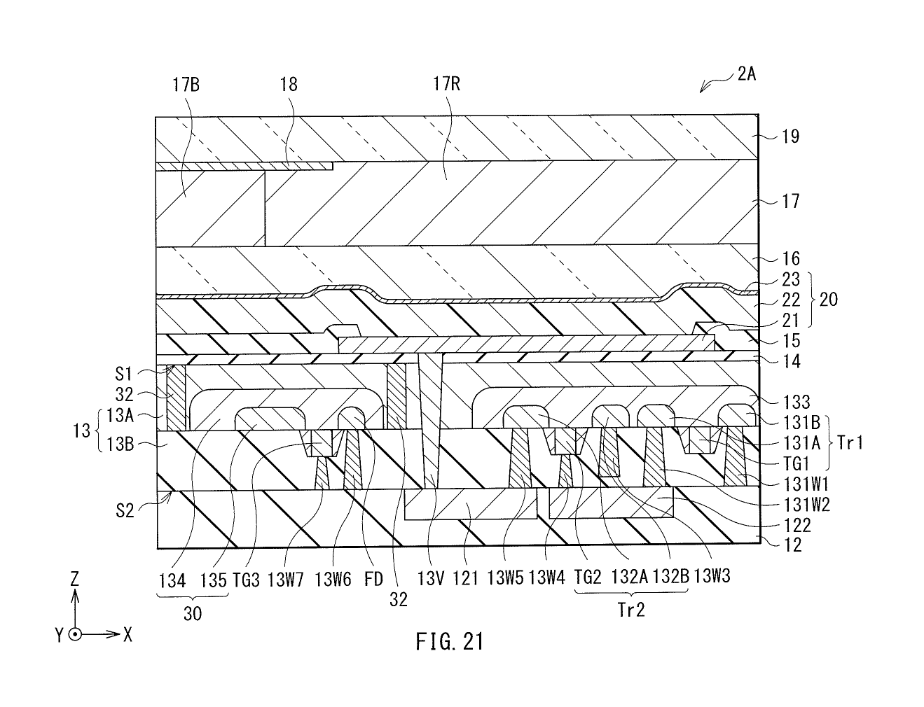

As illustrated in FIG. 21, a shield section (shield section 32) which includes a highly light-blocking metal film made of, for example, copper, tungsten, or aluminum may be provided around the light-receiving section 30 (modification 2). In a display 2A having the shield section 32, light from the light-receiving section 30 is suppressed from leaking in adjoining pixels 10 and the formation regions of the write transistor Tr1 and drive transistor Tr2, so that light from the light-emitting section 20 is collected to the light-receiving section 30 more efficiently. The shield section 32 is provided in a groove of the Si layer 13A, similar to the above shield section 31 of the second embodiment, and may be formed by embedding, for example, an insulating film and a metal film in the groove in this order. This insulating film may be a silicon oxide film or a silicon nitride film, for example.

### Third Embodiment

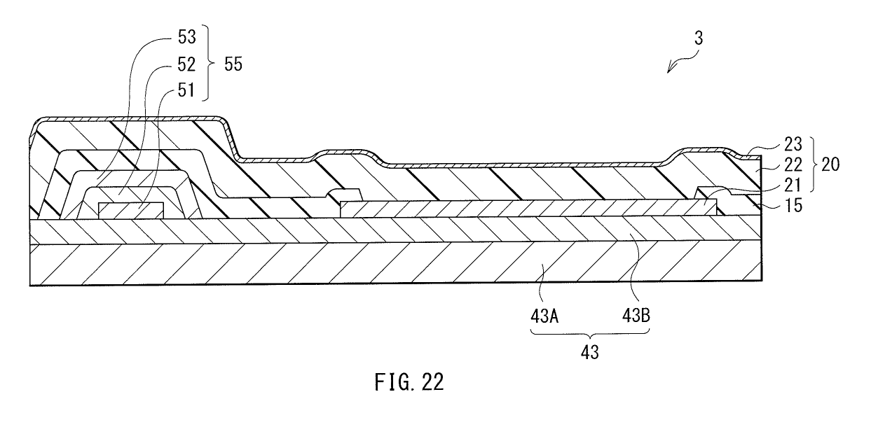

FIG. 22 illustrates a configuration of a cross section of a main part of a display (display 3) according to a third embodiment. In the display 3, both the light-emitting section 20 and a light-receiving section (light-receiving section 55) are provided on a surface of a substrate (substrate 43). Except for this, the display 3 has the same configuration as in the display 1, and its function and effect are also the same as those of the display 1. In FIG. 22, the protective layer 16, the CF layer 17, and the counter substrates 19 (see FIG. 1, etc.) are not illustrated.

The substrate 43 may be formed by, for example, stacking a TFT layer 43B on a tabular member 43A; both the light-emitting section 20 and the light-receiving section 55 are provided on the TFT layer 43B. The tabular member 43A may be configured with a film or a sheet made of, for example, quartz, glass, silicon (Si), metal foil, or resin. The TFT layer 43B is provided with transistors, such as the write transistor Tr1 and the drive transistor Tr2, that drive the light-emitting section 20 (see FIG. 3). In addition, the TFT layer 43B is also provided with wires connected to the light-emitting section 20 and the light-receiving section 55.

The light-receiving section 55 is disposed at a location adjoining the light-emitting section 20 in planar view, and may be provided for each pixel 10 (see FIG. 2), for example. The light-receiving section 55 has a lower electrode 51, a photoelectric conversion film 52, and an upper electrode 53 in this order with respect to the substrate 43. The light-receiving section 55 generates signal electric charges (for example, electrons) in response to light from the light-emitting section 20. These signal electric charges are extracted from the lower electrode 51, and is then transported to a correction circuit 50 as the light-receiving signal 30A (FIG. 4). The lower electrode 51, the photoelectric conversion film 52, and the upper electrode 53 are patterned for each light-receiving section 55.

The lower electrode 51 may be provided, for example, on the same layer as the first electrode 21 of the light-emitting section 20, and may be electrically connected to the correction circuit 50 (see FIG. 4), for example, through a wiring of the TFT layer 43B. A material of the lower electrode 51 may be the same as that of the first electrode 21, which may be, for example, aluminum. The photoelectric conversion film 52 absorbs light of a certain wavelength (visible light) generated by the light-emitting section 20, and generates pairs of electron and hole. A material of the photoelectric conversion film 52 may be, for example, copper indium gallium selenide (CIGS) or an organic photoelectric conversion material. One (for example, hole) of each pair of electron and hole generated by the photoelectric conversion film 52 is discharged from the upper electrode 53. The upper electrode 53 may be electrically connected to the GND, for example, through a wire of the TFT layer 43B. A material of the upper electrode 53 may be, for example, a light-transmissive, conductive material which may be the same as that of the second electrode 23 in the light-emitting section 20. The upper electrode 53 is covered with the element isolation layer 15, and the element isolation layer 15 is covered with the organic layer 22 and the second electrode 23 which both extend from the light-emitting section 20. The reflecting section 18 may be provided at a location opposing the light-receiving section 55, similar to the display 1 (see FIG. 1).

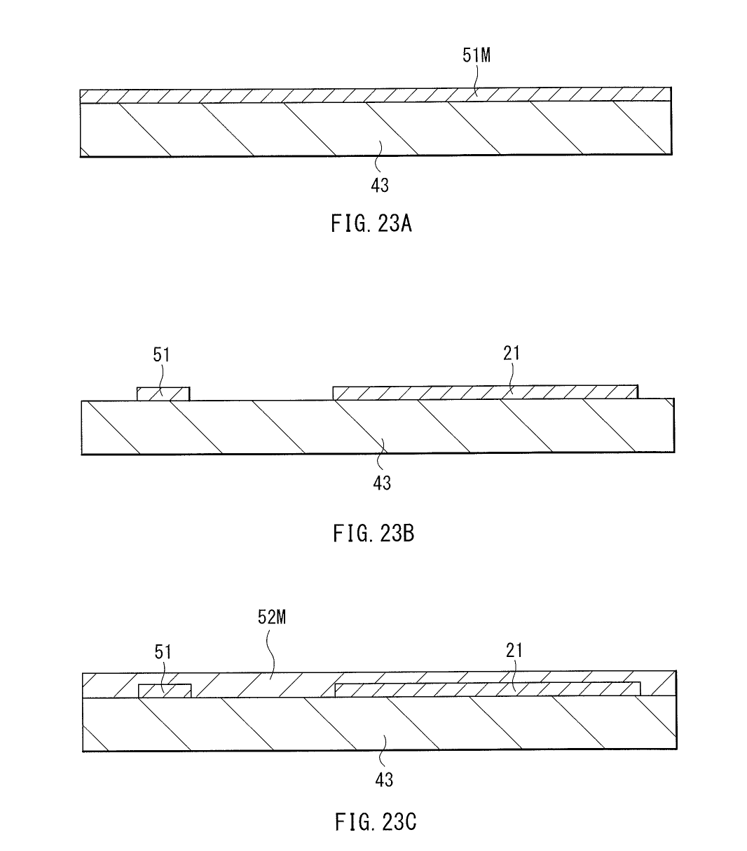

The display 3 configured above may be manufactured, for example, through processing described below (see FIGS. 23A to 25C).

First, a conductive film 51M is formed throughout a surface of the substrate 43, for example, by a sputtering method (see FIG. 23A). Subsequently, the conductive film 51M is patterned by dry or wet etching, so that the lower electrode 51 is formed (see FIG. 23B). The first electrode 21 may be formed from the conductive film 51M, simultaneously with the formation of the lower electrode 51.

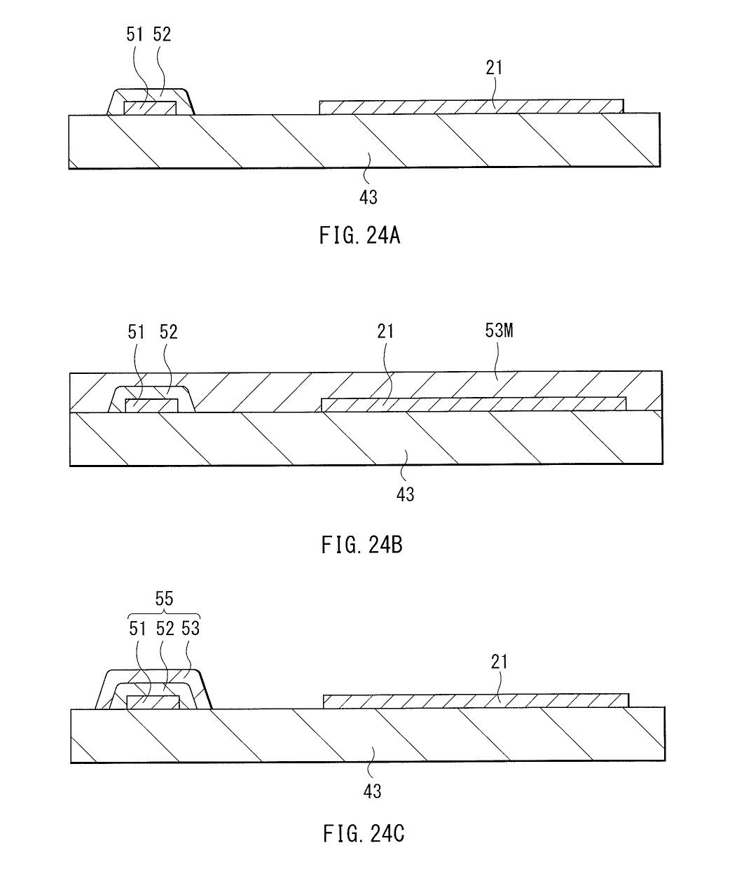

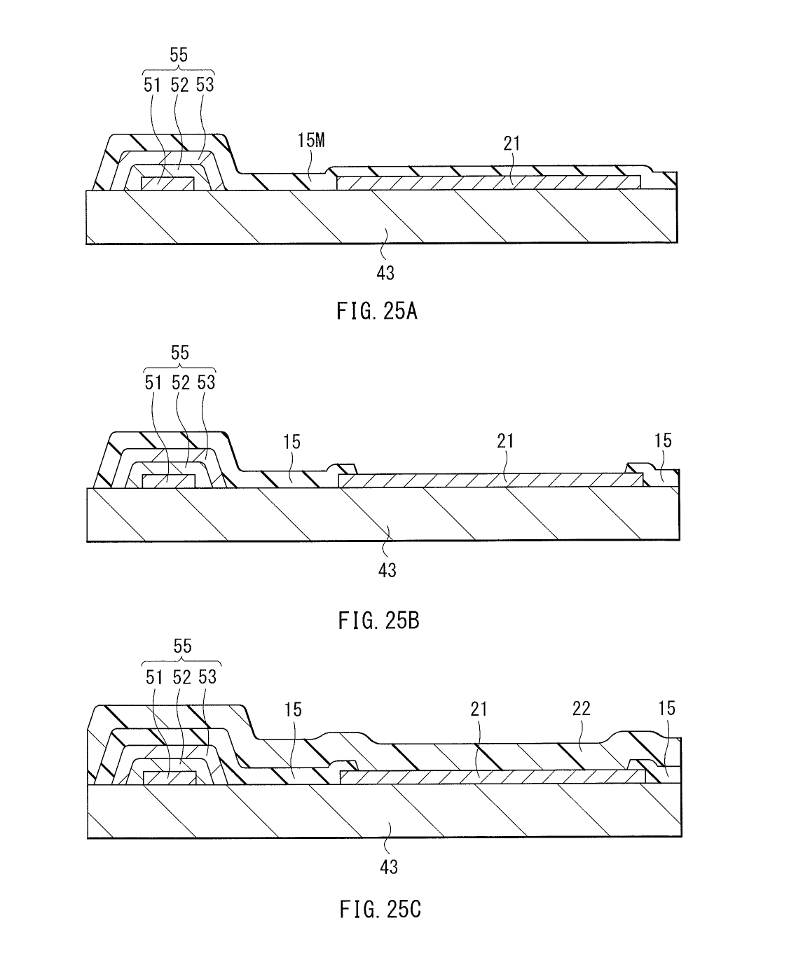

A photoelectric conversion film 52M is formed throughout the surface of the substrate 43, for example, by the sputtering method (see FIG. 23C). The photoelectric conversion film 52M is then patterned, so that the photoelectric conversion film 52 which covers the upper surface and side of the lower electrode 51 is formed (see FIG. 24A). Subsequently, a light transmissive, conductive film 53M may be formed, for example, throughout the surface of the substrate 43 (see FIG. 24B). The conductive film 53M is then patterned so that the upper electrode 53 is formed on photoelectric conversion film 52 (see FIG. 24C). The upper electrode 53 may cover, for example, the upper surface and side of the photoelectric conversion film 52. Through above processing, the light-receiving section 55 is formed. After the provision of the light-receiving section 55, an insulating film 15M is formed throughout the surface of the substrate 43 (see FIG. 25A). The element isolation layer 15 is then formed by providing an opening in part of the insulating film 15M to expose a surface of the first electrode 21 (see FIG. 25B). After the provision of the element isolation layer 15, the organic layer 22 and the second electrode 23 are formed throughout the surface of the substrate 43 in this order, so that the light-emitting section 20 is formed (see FIG. 25C). The subsequent processing is performed in a similar manner to the display 1. Then, the display 3 may be completed.

The light-receiving section 55 in the above display 3 receives part of light generated by the light-emitting section 20 in a similar manner to the light-receiving section 30 in the display 1 (see FIGS. 1 and 7). The light-receiving section 55 formed on the surface of the substrate 43 is provided at a location closer to the light-emitting section 20 than the light-receiving section 30 formed in the interior of the substrate 13. This enables the light-receiving section 55 to directly receive the light generated by the light-emitting section 20, without using the reflecting section 18. It is thus possible to suppress the decrease in the amount of the light traveling from the light-emitting section 20 to the light-receiving section 55, thereby sending a more accurate light-receiving signal 30A to the correction circuit 50.

[Module]

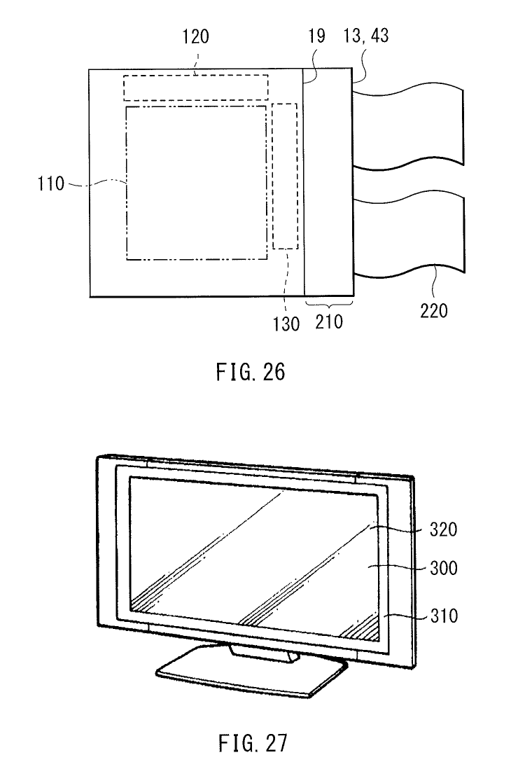

The displays 1, 1A, 2, 2A, and 3 (referred to simply as a display, below) in the foregoing embodiments and modifications may be built into various electronic apparatuses, such as exemplary applications 1 to 5 described below, for example, as a module illustrated in FIG. 26. In this module, for example, a region 210 exposed from the counter substrate 19 may be defined in peripheries of the substrates 13 and 43. In addition, an external connection terminal (not illustrated) may be formed in the exposed region 210. This external connection terminal may be configured with extended wires from the signal line drive circuit 120 and the scanning line drive circuit 130. The external connection terminal may be provided with a flexible printed circuit (FPC) board 220 to which a signal is input and from which a signal is output.

[Exemplary Application 1]

FIG. 27 illustrates an appearance of a television system that employs the display in any one of the foregoing embodiments and the like. This television system may have, for example, an image display screen section 300, a front panel 310, and a glass filter 320. In this case, the image display screen section 300 may be configured with the display in any one of the foregoing embodiments and the like.

[Exemplary Application 2]

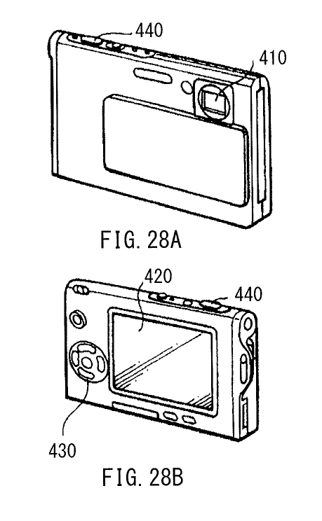

FIGS. 28A and 28B illustrate an appearance of a digital camera that employs the display in any one of the foregoing embodiments and the like. This digital camera may have: for example, a light-emitting section 410 for a flash; a display section 420; a menu switch 430; and a shutter button 440. In this case, the display section 420 may be configured with the display in any one of the foregoing embodiments and the like.

[Exemplary Application 3]

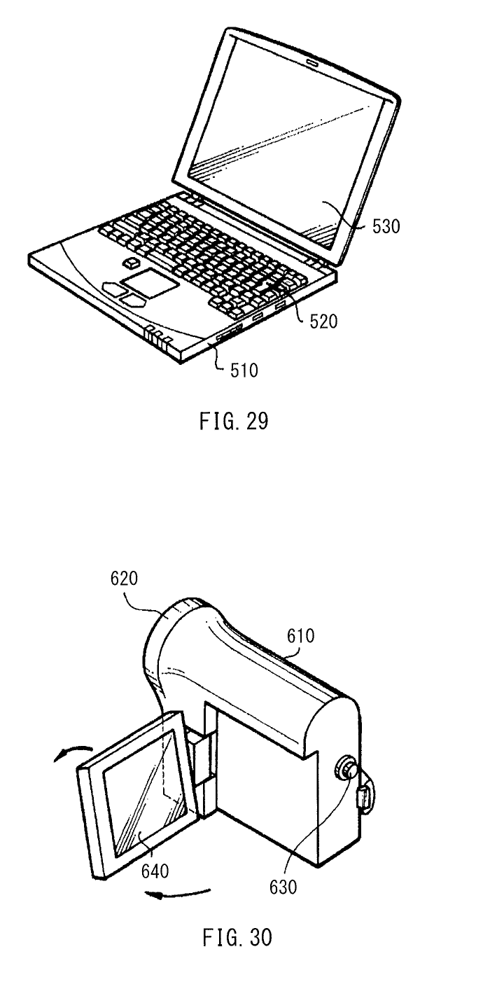

FIG. 29 illustrates an appearance of a notebook computer that employs the display in any one of the foregoing embodiments and the like. This notebook computer may have: for example, a main body 510; a Keyboard 520 through which an operation of inputting characters and the like is performed; and a display section 530 that shows an image. In this case, the display section 530 may be configured with the display in any one of the foregoing embodiments and the like.

[Exemplary Application 4]

FIG. 30 illustrates an appearance of a video camera that employs the display in any one of the foregoing embodiments and the like. This video camera may have: for example, a main body 610; a lens 620, used to capture a subject, that is provided on the front surface of the body part 610; an image pickup start/stop switch 630; and a display section 640. In this case, the display section 640 may be configured with the display in any one of the foregoing embodiments and the like.

[Exemplary Application 5]

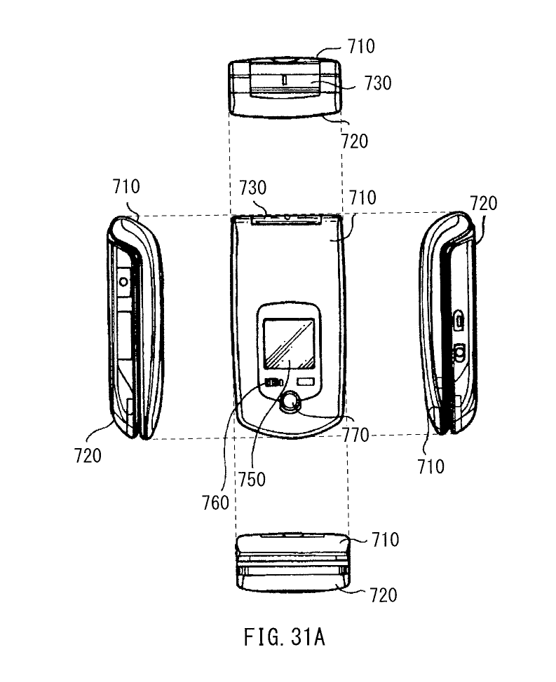

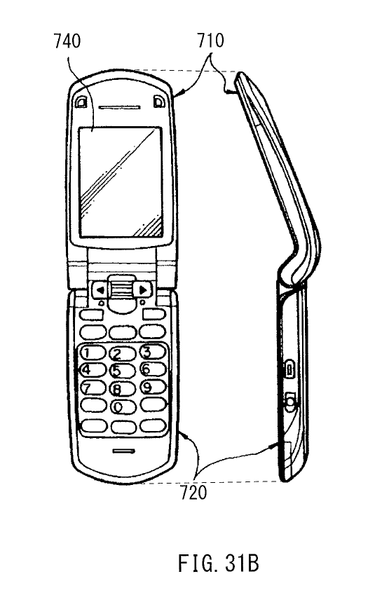

FIGS. 31A and 31B illustrate an appearance of a mobile phone that employs the display in any one of the foregoing embodiments and the like. This mobile phone may have, for example, an upper casing 710 and a lower casing 720 that are interconnected by a connecting part (hinge region) 730, and may further have a display 740, a sub-display 750, a picture light 760, and a camera 770. In this case, the display 740 or the sub-display 750 may be configured with the display in any one of the foregoing embodiments and the like.

Up to this point, the present application has been described using some example embodiments and modifications; however the present application is not limited to the foregoing embodiments and the like, and various other modifications and variations are possible. For example, the material and thickness of each layer, the method and condition of forming each film, and the like, all of which have been described in the forgoing embodiments and the like, are not restrictive, and other material, thickness, method and/or condition may be employed.

The foregoing embodiments and the like have been given regarding the case where the first electrode 21 and the second electrode 23 are used as an anode and a cathode, respectively. However the arrangement of the anode and the cathode may be reversed, more specifically, the first electrode 21 and the second electrode 23 may be used as a cathode and an anode, respectively. Moreover, the present application is applicable to bottom emission type displays.

The present application is also applicable to, for example, self-luminous displays other than organic EL displays, such as inorganic EL displays in which the light-emitting section 20 has an inorganic layer.

In the foregoing embodiments and the like, the concrete configurations of the write transistor Tr1 and the drive transistor Tr2 have been described; however the arrangement of the write transistor Tr1 and the drive transistor Tr2 may be reversed or another transistor may be disposed directly below the light-emitting section 20. In the foregoing embodiments and the like, the respective source-and-drain regions of the write transistor Tr1 and the drive transistor Tr2 are provided in the N-type well region, and the light-receiving section 30 is provided in the P-type well region. However, the respective source-and-drain regions of the write transistor Tr1 and the drive transistor Tr2 may be provided in a P-type well region, and the light-receiving section 30 may be provided in an N-type well region.

Furthermore, the technology encompasses any possible combination of some or all of the various embodiments described herein and incorporated herein.

It is possible to achieve at least the following configurations from the above-described example embodiments of the disclosure.

(1) A display including:

a light-emitting section provided in a display region; and

a light-receiving section provided in the display region, and configured to receive light from the light-emitting section.

(2) The display according to (1), further including:

a pixel drive circuit configured to drive the light-emitting section; and

a correction circuit configured to send a correction signal to the pixel drive circuit in accordance with an amount of the light received by the light-receiving section.

(3) The display according to (1) or (2), wherein the light-emitting section and the light-receiving section are provided on a surface of a substrate.
(4) The display according to any one of (1) to (3), wherein the light-receiving section includes a photoelectric conversion film between a pair of electrodes.
(5) The display according to (2), wherein the light-emitting section is provided on a surface of a substrate, and the light-receiving section is provided in an interior of the substrate.
(6) The display according to (5), wherein the light-receiving section includes a photodiode.
(7) The display according to (5) or (6), wherein the substrate includes a silicon layer.
(8) The display according to (7), wherein the light-receiving section is provided in the vicinity of a rear surface of the silicon layer.
(9) The display according to any one of (5) to (8), wherein the pixel drive circuit includes a transistor, and the transistor is provided at a location that is overlapped in planar view with the light-emitting section.
(10) The display according to (9), wherein the transistor and the light-receiving section are provided for each pixel, and the transistor and the light-receiving section are provided at locations that are adjacent to each other.
(11) The display according to (10), further including a shield section provided between the transistor and the light-receiving section.
(12) The display according to (11), wherein the shield section includes an insulating film embedded in a groove of the substrate.
(13) The display according to (11), wherein the shield section includes a metal film embedded in a groove of the substrate.
(14) The display according to (11), wherein the shield section includes copper embedded in a groove of the substrate.
(15) The display according to any one of (11) to (14), wherein the shield section is provided surrounding the light-receiving section.
(16) The display according to any one of (5) to (15), further including a reflecting section that opposes the substrate,

wherein the light from the light-emitting section is reflected by the reflecting section, and the light reflected by the reflecting section enters the light-receiving section.

(17) The display according to (16), wherein a surface, which opposes the substrate, of the reflecting section includes a parabolic curved surface.
(18) An electronic apparatus provided with a display, the display including:

a light-emitting section provided in a display region; and

a light-receiving section provided in the display region, and configured to receive light from the light-emitting section.

(19) A method of driving a display, the method including:

driving, using a pixel drive circuit, a light-emitting section that is provided in a display region;

receiving, using a light-receiving section that is provided in the display region, light from the light-emitting section; and

sending a correction signal to the pixel drive circuit from a correction circuit in accordance with an amount of the light received by the light-receiving section.

(20) A method of manufacturing a display, the method including:

forming a light-emitting section in a display region; and

forming a light-receiving section in the display region, the light-receiving section being configured to receive light from the light-emitting section.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display comprising:
a light-emitting section provided in a display region; and
a light-receiving section provided in the display region, and configured to receive light from the light-emitting section.

2. The display according to claim 1, further comprising:
a pixel drive circuit configured to drive the light-emitting section; and
a correction circuit configured to send a correction signal to the pixel drive circuit in accordance with an amount of the light received by the light-receiving section.

3. The display according to claim 2, wherein the light-emitting section and the light-receiving section are provided on a surface of a substrate.

4. The display according to claim 3, wherein the light-receiving section includes a photoelectric conversion film between a pair of electrodes.

5. The display according to claim 2, wherein the light-emitting section is provided on a surface of a substrate, and the light-receiving section is provided in an interior of the substrate.

6. The display according to claim 5, wherein the light-receiving section includes a photodiode.

7. The display according to claim 5, wherein the substrate includes a silicon layer.

8. The display according to claim 7, wherein the light-receiving section is provided in the vicinity of a rear surface of the silicon layer.

9. The display according to claim 5, wherein the pixel drive circuit includes a transistor, and the transistor is provided at a location that is overlapped in planar view with the light-emitting section.

10. The display according to claim 9, wherein the transistor and the light-receiving section are provided for each pixel, and the transistor and the light-receiving section are provided at locations that are adjacent to each other.

11. The display according to claim 10, further comprising a shield section provided between the transistor and the light-receiving section.

12. The display according to claim 11, wherein the shield section comprises an insulating film embedded in a groove of the substrate.

13. The display according to claim 11, wherein the shield section comprises a metal film embedded in a groove of the substrate.

14. The display according to claim 11, wherein the shield section comprises copper embedded in a groove of the substrate.

15. The display according to claim 11, wherein the shield section is provided surrounding the light-receiving section.

16. The display according to claim 5, further comprising a reflecting section that opposes the substrate,
wherein the light from the light-emitting section is reflected by the reflecting section, and the light reflected by the reflecting section enters the light-receiving section.

17. The display according to claim 16, wherein a surface, which opposes the substrate, of the reflecting section comprises a parabolic curved surface.

18. An electronic apparatus provided with a display, the display comprising:
a light-emitting section provided in a display region; and
a light-receiving section provided in the display region, and configured to receive light from the light-emitting section.

19. A method of driving a display, the method comprising:
driving, using a pixel drive circuit, a light-emitting section that is provided in a display region;
receiving, using a light-receiving section that is provided in the display region, light from the light-emitting section; and
sending a correction signal to the pixel drive circuit from a correction circuit in accordance with an amount of the light received by the light-receiving section.

20. A method of manufacturing a display, the method comprising:
forming a light-emitting section in a display region; and
forming a light-receiving section in the display region, the light-receiving section being configured to receive light from the light-emitting section.
